(19) United States
(12) Patent Application Publication
(10) Pub. No.: US 2012/0114309 A1
(43) Pub. Date: May 10, 2012

(54) SYSTEM AND METHOD FOR DISTRIBUTING A MEDIA PRODUCT BY PROVIDING ACCESS TO AN EDIT DECISION LIST

(76) Inventors: Barjinderpal S. Gill, Los Gatos, CA (US); Chung Ming Tam, Ottawa (CA); Paramjit S. Gill, Ottawa (CA)

(21) Appl. No.: 13/292,980

(22) Filed: Nov. 9, 2011

Related U.S. Application Data
(63) Continuation of application No. 11/478,392, filed on Jun. 28, 2006, now abandoned.

(30) Foreign Application Priority Data
May 12, 2006 (CA) 2,546,746

(51) Int. Cl. G11B 27/02

(52) U.S. Cl. 386/281; 386/E05.003

(57) ABSTRACT

The present invention provides a system and method for distributing a media product by providing access to an edit decision list. The system comprises: an edit decision list corresponding to the final product, said edit decision list comprising statements and instructions for generating the final product from said one or more content elements; a selection means for allowing the consumer to select the edit decision list from a first source location; a computing device accessible to the consumer and having access to said one or more content elements from one or more second source locations distinct from said first source location; and a communication medium for providing said computing device access to said edit decision list; wherein said computing device is configured to access said edit decision list and implement said statements and instructions thereof to generate the final product for consumption by the consumer.

### CROSS-REFERENCE TO RELATED APPLICATIONS

This application is a continuation of U.S. patent application Ser. No. 11/478,392, filed May 14, 2007, which claims benefit of Canadian patent application serial number 2,546,746, filed May 12, 2006. Each of the aforementioned related patent applications is herein incorporated by reference.

### BACKGROUND OF THE INVENTION

1. Field of the Invention

The present invention relates to text, image, video, audio, and multimedia content production and distribution methods, and specifically to a system and method for distributing a media product through the distribution of an Edit Decision List (EDL).

2. Description of the Related Art

An Edit Decision List (EDL) is a way of representing an edit of a particular piece of content. The EDL is a document (which can be in many different formats) that contains a list of “events”. An event describes a step in assembling or manipulating media content in order to create a final product, similar to the way in which a recipe describes the steps involved in preparing a dish from different ingredients. Each event can be described in a number of ways, including but not limited to the source of content (such as tape name or file name), different content elements (as defined, for example, by a time code and description), transitions related to an event (cuts, dissolves, wipes, etc.), and the transition durations. EDLs are currently used in the television, film, and video industries to create edited products without directly modifying the source elements. EDLs can be created in a number of different formats, for example CMX, GVG, Sony, Final Cut Pro, Avid, and the like. In video production, the Society of Motion Picture and Television Engineers (SMPTE) provides a set of standards, for example, SMPTE 377M-2004 and SMPTE 400M-2004, so that all video-editing systems that recognize this standard can edit the same content. The Advance Authoring Format (AAF) developed by the AAF Association is another example of an industrial standard. As a result of the AAF standards for videos and films, an EDL can be generated to describe explicitly how the content should be rearranged, modified, and assembled.

Edit Decision Lists arose out of the development of non-linear film, television and video editing. Non-linear editing is an editing process that involves an editor accessing different sections of recorded content, such as a film reel or audio tape in an order determined by the editor as opposed to the order in which the content is set out on the reel or tape. Although modern non-linear editing processes work almost exclusively with digital content, the concept of non-linear editing is analogous to the traditional “cut and tape” technique of film editing where individual frames from different film strips were physically cut out and taped together into a new, edited, film strip. One of the advantages of modern non-linear editing, however, is that the process does not affect the original content, allowing for far greater flexibility in editing. As long as the content is properly identified and encoded, (i.e. the content is divided into organized sub-components or elements) the editing, content creation, and product presentation are all relatively simple processes, generally implemented via the creation of an EDL.

Since its inception, EDL technology has undergone extensive development. For example, the film industry has created specialized instruments, such as non-linear editors, designed explicitly to carry out the workflow required in non-linear editing. The CMX-300 was the first non-linear editor to illustrate the advantages of a non-linear editing process over the conventional editing process, such as a decrease in editing time. Since then, many researchers have made improvements to the editing process, especially in the video and film industry. See, for example, U.S. Pat. No. 6,453,112 to Imahashi et al., US Publication No. 2001/0036356 to Weaver et al., and U.S. Pat. No. 6,948,128 to Ibrahim et al.

More recent progress in the development of the non-linear editing process has led researchers to improve on the creation of EDLs, and have moved beyond current uses of EDLs to develop different applications. For example, US Patent Publication No. 2004/0133850 to Nitzberg et al. describes the use of an EDL as a means to protect content from unauthorized distribution during the editing process by allowing an editor access to a lower quality form of the content. The resulting EDL can then be applied to the distribution-quality content possessed by the content provider to produce the final product.

U.S. Pat. No. 5,553,221 to Reimer et al. describes a method for enabling a consumer to create a unique version of a film through the creation of a personalized EDL. U.S. Pat. No. 6,714,723 to Abecassis offers an alternative to this system by creating an electronically integrated video-on-demand system which assembles customized versions of a video based on a consumer's pre-selected content preferences.

The above examples, however, do not provide adequate means for distributing digital media products through the distribution of Edit Decision Lists (EDL). Therefore, there is a need for a system and method that overcomes the drawbacks of known systems.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a system and method for distributing a media product by providing access to an edit decision list.

According to an embodiment of the present invention, there is provided a system for providing a consumer access to a final product comprising one or more content elements, the system comprising: an edit decision list corresponding to the final product, said edit decision list comprising statements and instructions for generating the final product from said one or more content elements; a selection means for allowing the consumer to select the edit decision list from a first source location; a computing device accessible to the consumer and having access to said one or more content elements from one or more second source locations distinct from said first source location; and a communication medium for providing said computing device access to said edit decision list; wherein said computing device is configured to access said edit decision list and implement said statements and instructions thereof to generate the final product for consumption by the consumer.

According to an embodiment of the present invention, there is provided a method of providing a consumer access to a final product comprising one or more content elements: having the consumer select an edit decision list referencing said one or more content elements from a first source location; providing the consumer access to said selected edit decision list; providing the consumer access to the one or more content elements referenced by said selected edit decision list from one or more second source locations distinct from said first source location; having the consumer generate the final product from said one or more content elements.

According to an embodiment of the present invention, there is provided a system for tracking the use of a final product by a consumer, the final product comprising one or more content elements to be assembled the system comprising: an edit decision list corresponding to the final product, said edit decision list comprising statements and instructions for generating the final product from one or more content elements and comprising instructions for inserting a unique identifier into said final product at the time of assembly; a selection means for allowing said consumer to select the edit decision list from a first source location; a computing device accessible to said consumer and having access to said one or more content elements from one or second source location distinct from said first source location; and a communication medium for providing said computing device access to said edit decision list; wherein said computing device is configured to access said edit decision list and implement said statements and instructions thereof to generate said unique final product for consumption by the consumer and wherein said unique identifier can be used to associate said final product with either or both of said first or said second source location.

According to an embodiment of the present invention, there is provided a system for providing a consumer access to two or more final products comprising one or more content elements wherein each of said two or more final products are specifically tailored to appeal to a consumer based on one or more criteria, the system comprising: an edit decision list corresponding to said two or more final products, said edit decision list comprising statements and instructions for generating said two or more final products from one or more content elements; a selection means for allowing the consumer to select the edit decision list from a first source location; a computing device accessible to the consumer and having access to said one or more content elements from one or more second source locations distinct from said first source location; a communication medium for providing said computing device access to said edit decision list; and an input means for allowing the consumer to provide input, wherein said input corresponds to one or more criteria relating to said consumer; and wherein said computing device is configured to access said edit decision list and implement said statements and instructions thereof and said input to generate a particular final product for consumption by the consumer.

According to an embodiment of the present invention, there is provided a system for providing a consumer access to two or more final products comprising one or more content elements wherein each of said two or more final products are specifically tailored to appeal to a consumer based on one or more criteria, the system comprising: an edit decision list corresponding to said two or more final products, said edit decision list comprising two or more sublists, wherein each sublist comprises statements and instructions for generating one of said two or more final products from one or more content elements; a selection means for allowing the consumer to select the edit decision list from a first source location; a computing device accessible to the consumer and having access to said one or more content elements from one or more second source locations distinct from said first source location; a communication medium for providing said computing device access to said edit decision list; and an input means for allowing the consumer to provide input, wherein said input corresponds to one or more criteria relating to said consumer; and wherein said computing device is configured to access said edit decision list, select one of said two or more sublists based on said input, and implement said statements and instructions within said sublist to generate a particular final product for consumption by the consumer.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a graphic representation of the process of creating an edit decision list.

FIG. 2 is a graphic representation of the process of non-linear editing as applied to video content.

FIG. 3 is graphic representation of the process of non-linear editing as applied to multiple content sources.

FIG. 4 is graphic representation of the process of non-linear editing as applied to text content.

FIG. 5 is graphic representation of the process of non-linear editing as applied to audio content.

FIG. 6 is graphic representation of the process of non-linear editing as applied to multimedia content.

FIG. 7 is a process diagram of the steps required to create an edit decision list.

FIG. 8 is a process diagram of the steps required to create a final product using an edit decision list.

FIG. 9A is a graphic representation of media production.

FIG. 9B is a graphic representation of media production using edit decision lists according to an embodiment of the invention.

FIG. 10 is a graphic representation of the process of purchasing an EDL and combining it with content to produce a final product according to an embodiment of the invention.

FIG. 11 is a process diagram of the process of FIG. 10 according to an embodiment of the invention.

FIG. 12 is a graphic representation of the process outlined in FIGS. 10 and 11 and identifies where value is created according to an embodiment of the invention.

FIG. 13 is a graphic representation of the process of buying and selling access to an EDL and content wherein the EDL can be used to direct a consumer to the necessary content source required to generate a final product, according to an embodiment of the invention.

FIG. 14 is provided a diagram of the steps of the process represented in FIG. 13 according to an embodiment of the invention.

FIG. 15 is a representation of the same process as in FIGS. 13 and 14 and identifies where value is created according to an embodiment of the invention.

FIG. 16 is a graphic representation of the process of creating and providing access to a customized EDL according to an embodiment of the invention.

FIG. 17 is a process diagram of the process illustrated in FIG. 16 according to an embodiment of the invention.

FIG. 18 is a graphic representation of the process provided in FIGS. 16 and 17 and highlights the step in which value is created, according to an embodiment of the invention.

FIG. 19 is a graphic representation of the process of creating and distributing an interactive EDL wherein the consumer provides input to generate an individualized EDL according to one embodiment of the invention.

FIG. 20 is a process diagram that describes the actions between the editor, the service provider and the consumer with regard to the creation, distribution and use of an interactive EDL according to one embodiment of the invention.

FIG. 21 is a graphic representation of the process represented in FIGS. 19 and 20 indicating where value is created according to one embodiment of the invention.

FIG. 22 is a graphic representation of the process of distributing and processing an EDL that references streaming content.

FIG. 23 is the corresponding flowchart for the processes described in FIG. 22.

FIG. 24 is a graphic representation of the process illustrated in FIGS. 22 and 23 wherein the step in which value is created is highlighted.

FIG. 25 is a graphic representation of the process of negotiating the right to modify an EDL according to an embodiment of the present invention.

FIG. 26 is a process diagram detailing the steps involved in the process represented in FIG. 25.

FIG. 27 is a graphic representation of the process outlined in FIGS. 25 and 26 according to an embodiment of the invention.

FIG. 28 is a graphic representation of a process of distributing an EDL and tracking the use of content referenced by the EDL by a consumer through the use of a royalty tracker, according to an embodiment of the invention.

FIG. 29 is a process diagram illustrating the steps of the process of FIG. 28A, according to an embodiment of the invention.

FIG. 30 provides a graphic representation of the process outlined in FIGS. 28 and 29 and illustrates at what stage in this process value is created.

FIG. 31 provides a graphic representation of the process of creating and distributing an EDL referencing advertising content, according to an embodiment of the invention.

FIG. 32 is the corresponding flowchart for the processes described in FIG. 31, according to an embodiment of the invention.

FIG. 33 is a graphic representation of another embodiment of the invention in which a consumer obtains advertising content from a content provider after gaining access to an EDL that referencing the advertising content.

### DETAILED DESCRIPTION

Definitions

The term “content” or “source content” is used to define any content referenced by an EDL describing an editing process resulting in a given final product. Examples of content may include, but are not limited to, audio, which can be in digital formats such as AAF, AAC, AC-3, AIF, KAR, MIDI, MP2, MP3, MPA, OGG, RAM, RMF, RMX, SMF, WAV, and WMA; video, which can be in digital formats such as AVI, DIR, DIVX, FLV, MOV, MP4, MPG, OGM, QT, RM, SWF, WMV and VID and other forms of content information such as text, images, multimedia content, and others. In theory, there are no restrictions on the types of content that can be incorporated into a final product using an EDL. The container for the content, or the means by which the content is made available can be, for example, in the form of an electronic file that can be accessed over a network, such as for example, the internet, a local area network, or a peer-to-peer network, on a storage medium such as a DVD or CD, in the form of streaming media, or others. In the context of the present invention, existing media products such as music albums, movies and books can fall within the definition of content if they are referenced in an EDL.

The term “content elements” is used to define a portion of content that is specifically defined as part of an EDL. A content element can comprise any of the whole or part of a content source.

The term “product” or “final product” is used to define what is produced through the process of selecting, arranging and/or modifying content according to the instructions contained within an EDL. Traditionally, the product is seen as the end result of and purpose for the creative process. Within the context of the present disclosure, a product comprises an arrangement of selected content.

The term “Edit Decision List” or “EDL” is used to define the document, file and/or computer readable medium embodying statements and instructions for enabling the assembly of one or more final products from one or more content elements. The EDL can be provided and amended in a number of formats and configured to be read and interpreted by different processing platforms in order to assemble the final product comprising the selected content elements.

Unless defined otherwise, all technical and scientific terms used herein have the same meaning as commonly understood by one of ordinary skill in the art to which this invention belongs.

The present invention relates to a system and method for providing access to media products through access to, distribution and/or commercialization of EDLs rather than the final product itself. This leverages the flexibility of the editing process and the power of modern personal computers to provide new services to the consumer. In the present invention, the EDL and the content source have a value above and beyond the value of the final product.

The present invention can be contrasted with the traditional business model for content creation whereby the value is placed solely on the final product. Traditionally, any content created and not incorporated into the final product is waste product to be “left on the cutting room floor” or in some cases bundled with the final product as an additional feature, such as, for example, studio tracks on audio CDs, and deleted or extended scenes and outtake reels in DVDs. In rare cases, more than one version of a final product is released, for example, a director's cut of a film as opposed to the version originally released in theatres. However, the majority of additional content created on a project possesses little to no value. Because the traditional business model centres all of the value on a single product, and because the process of content creation is increasingly expensive, there is a great deal of financial risk borne by the content provider. This, in turn, can limit the creative process, as content providers attempt to create final products that will appeal to the largest cross-section of the audience, sometimes at the expense of the artistic quality of the product.

According to one embodiment of the present invention, the business paradigm shifts from distribution of a single product to providing access to EDLs and to sources of content associated therewith. By providing access to various content sources to editors, content that could currently be considered as waste has the potential to generate revenue. By providing access to, and optionally enabling the modification of an EDL, a content provider is no longer selling a single final product, but tools with the potential to create a near-infinite number of different final products. The creation of products that appeal to smaller markets can then take place without the risk being borne by the content provider, potentially resulting in greater revenues overall than that currently realized from a single “hit” product. Society in general can also benefit from the potential democratization of the tools of creation, similar to the recent revolution in print media enabled by the development of inexpensive self-publishing tools. By granting authors, editors and owners of an EDL value based on the control of the EDL, the present invention provides an alternative to traditional restrictions associated with source availability, final content production and distribution.

The present invention takes advantage of the power and versatility of the EDL and describes systems and methods for providing access to EDLs, whether through distribution, purchase, online-access and so on, as well as for providing access to content currently or ultimately associated with such EDLs, thereby enabling the generation of, and access to a selected final product. The concept of an EDL can be applied to any type of media, including text, images, audio or video. The type of edit decisions can include any form of manipulation and transform of the media as well as any software and/or hardware interaction or requirements. The present invention enables a system wherein content no longer needs to be delivered in its final form, but rather as instructions required to create the final form from available content.

Edit Decision Lists

The process of assembling edited content from different sources, for example creating a website, composing a musical score, or creating a film, can be broken down into a series of steps, each of which can be described in an EDL.

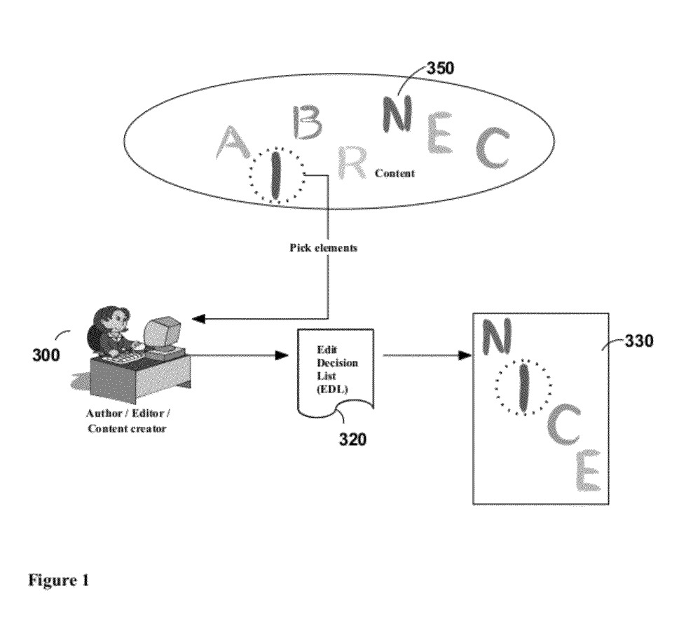

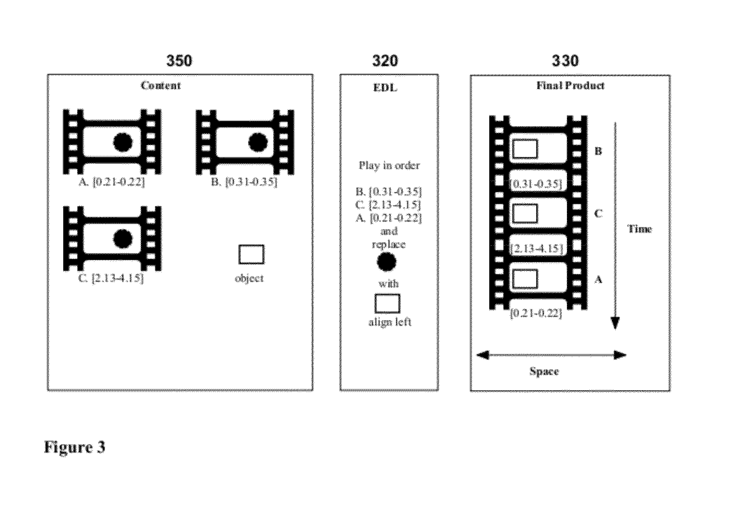

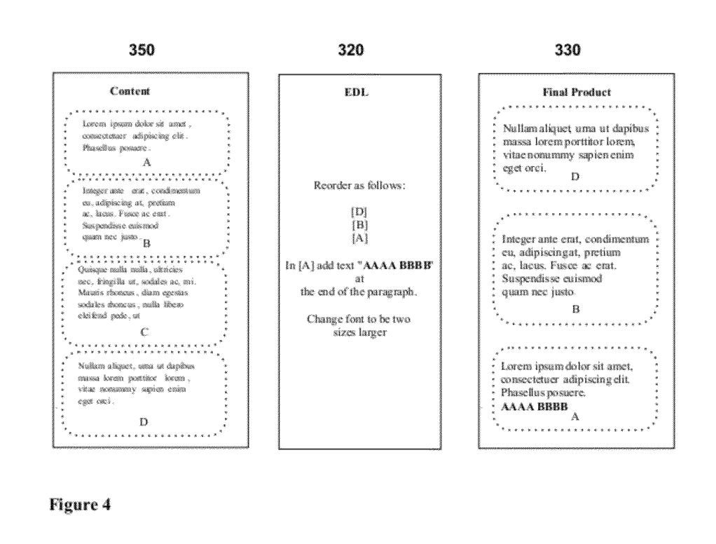

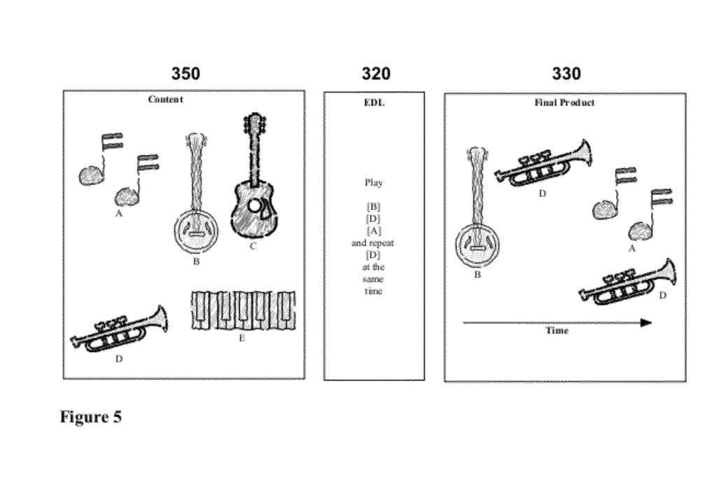

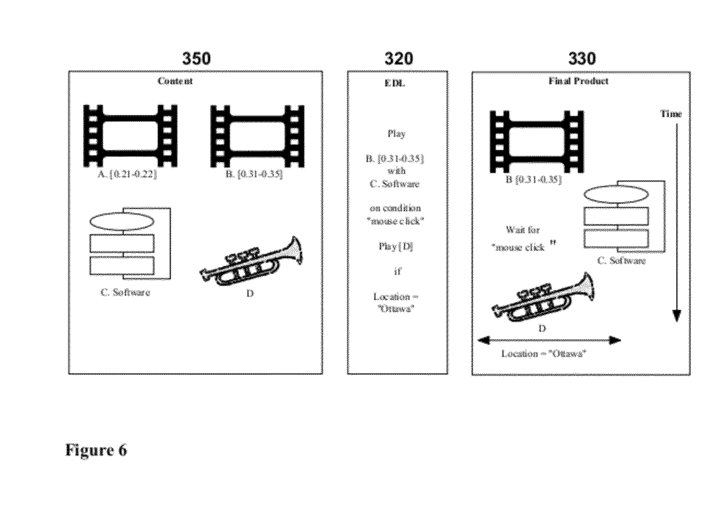

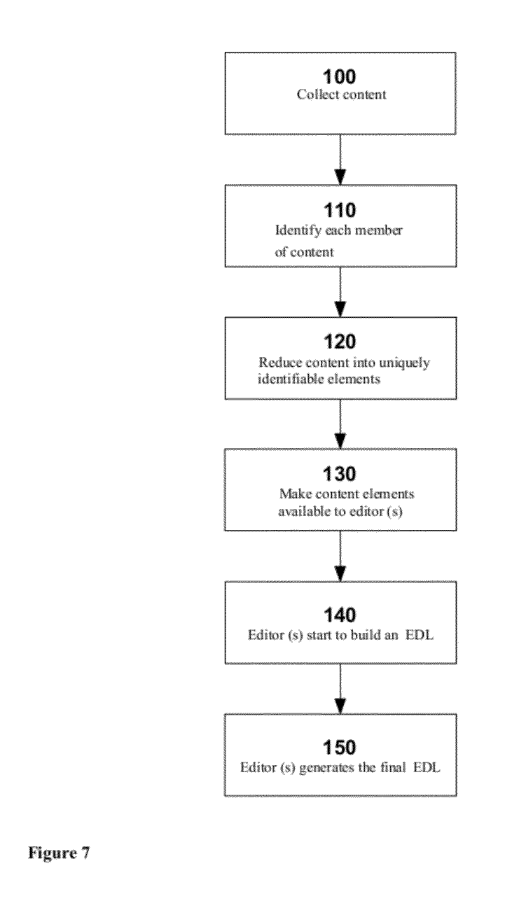

The process of creating an EDL is depicted in FIGS. 1 to 6 and is mapped in FIG. 7, and described in more detail below. A worker skilled in the art will appreciate that these stages are not exclusive in the creation of an EDL and that other steps may be required for the production of a particular EDL. A worker skilled in the art will also appreciate that while most content will likely be in a digital form, any type of content could be described and incorporated into an EDL without departing from the scope of the present invention.

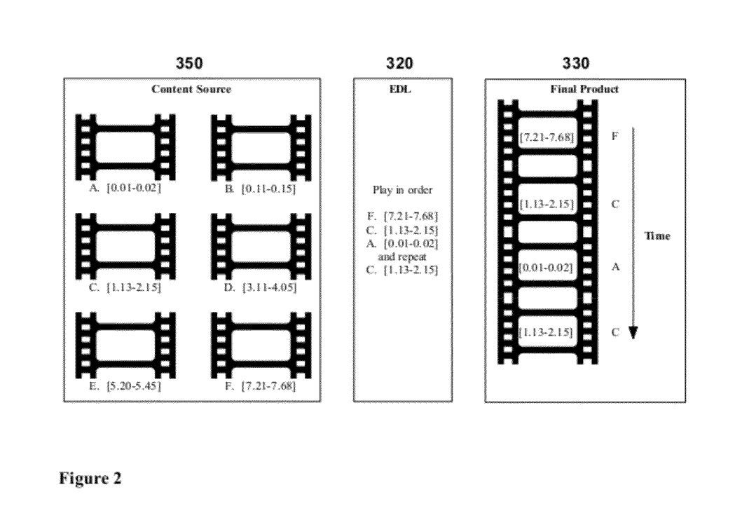

Building an EDL is an iterative process, which can vary based on the creativity and imagination of the editor. With reference to FIG. 1, on a general level, the editor 300 selects elements of content 350, and records instructions on how to combine and manipulate those elements of content 350 into an EDL 320. A final product 330 can then be created by combining and manipulating the content elements 350 according to the instructions in the EDL 320. FIGS. 2 to 6, illustrate at an even more general level, how elements of different types of source content 350 can be combined according to the instructions compiled in an EDL 320 to make a final product 330.

With reference to FIG. 7, a more detailed description of the process of creating an EDL begins with stage 100, in which an editor begins the EDL creation process by amassing the various types of content sources to be incorporated into the final product.

In the next step of the process of creating an EDL 110, the editor uniquely identifies each content source within each of the various types of content sources. For example, an audio content source may comprise one or more audio CDs. Each CD has a number of unique identifiers, such as the CD name, artist, Amazon Standard Item Number (ASIN). Videos and books can be identified by their International Standard Book Number (ISBN), a 10-digit number that uniquely identifies books and book-like products published internationally. If the content source does not already possess standard or third party identifiers, the editor can create an identification scheme to uniquely identify each member of the content source. Content can also be referenced by its location, such as a URL, in the case of web-based content, or a unique database reference identifier. According to one embodiment of the present invention, the EDL will be accessed separately from the content sources that it references. With reference to this embodiment, the references to content sources within the EDL should enable a consumer to locate those content sources after the creation of the EDL, for example via the internet, from a home collection, from one or more content repositories, from one or more content providers, or the like.

In step 120, each individual content source is then divided by the editor into smaller elements until the level of detail and control desired by the editor is achieved. For example, in an audio content source, a single audio CD can be divided into different music tracks and each track can then be subdivided into minutes and seconds according to its time signature. If the source content includes video content, standards such as the Society of Motion Picture and Television Engineers (SMPTE) time codes or the Advance Authoring Format (AFF) can be used to uniquely identify sub-elements within a video. Objects within digital video can also be identified by their relative position or pixel location in combination with a standard time code. For materials that are text based, unique identifiers can include the position of sentences, paragraphs or words, or can be identified using embedded tags or markers within the text. When applied to multimedia data, standardized formats, such as for example, the Semantic Web or Synchronized Multimedia Integration Language (SMIL) or others can be used to uniquely identify its elements. A worker skilled in the art will be aware of the particular industry standards that permit elements within different types of content to be described.

In the next step 130, the source content is available to the editor, who reviews the various elements in order to plan how they will eventually fit together into a final product.

Once the individual elements have been identified, the next step 140 is for the editor to reference the content by its identifier, and compile a list of directions describing how each member within the collection is to be identified and reduced into elements. Various standards exist to ensure consistency in language and format between EDLs created by different editors. For example, online content is described using standardized languages such as Hypertext Markup Language (HTML). A worker skilled in the art will be aware of common standards for editing various types of different content. For example, a worker skilled in the art would be aware of the correct way of referencing video or audio content by its time code.

In the next step 150, the editor begins to construct the EDL, using the identified content elements and a common language for describing combinations and manipulations of said elements. The EDL provides a description of how to rearrange the elements into the final product. Information found within the EDL would include the sequence of elements that are to appear in the final product. The EDL can also include instructions on manipulating each element. Examples of such manipulations could include adding special effects or color to an element. The EDL can also include instructions on manipulating the ways in which the elements are brought together in the final product. For example, fade-ins, fade-outs, zooms, or wipes may be used to lead into a new element, such as a new music track on an audio CD. The EDL can also include instructions on using special effects that manipulate properties within an element. For example, objects within a video element can be removed or replaced using digital editing techniques. In audio tracks, selected frequencies or sound signatures can be removed or replaced.

In one embodiment of the present invention, the EDL can include additional types of instructions that relate to the use of the EDL by third parties or of the final product that the EDL generates. Examples of such instructions include parameters that would define in what manner the EDL is applied and could include demographics of audiences who would be recipients of the EDL application such as age, sex, language, ethnicity, race, religion, and economic class; geographical region where the final product is to be displayed; valid duration of EDL use; and interactions with the external environment; for example, the use of a particular piece of software for viewing the final product. In another embodiment, a consumer can specify certain preferences that will affect the final content, such as parental controls to delete content the consumer deems inappropriate, or instructions to remove all advertising content.

As discussed above, in the present invention, the EDL itself has value above and beyond the final product that it creates. The expansion in power of personal computing devices coupled with the ability of the internet to act as a pipeline for multimedia content has the potential to allow an individual to assemble a final product as easily as a production house. In this new regime, it is easier and more flexible to provide the recipe for the content and allow the consumer to assemble the product themselves, namely using their own computing device and/or via tools accessed remotely using a communication device and provided by a service provider for assembling a given product for consumption. For example, the product could be assembled by the consumers on their own computing device for direct consumption; it could be assembled by the service provider upon request by the consumer for subsequent download thereto, or for direct viewing using a streaming video feature. Other such examples will become more apparent with reference to the following discussion and examples.

As will be understood by the person skilled in the art, the embodiments of the present invention provide a new paradigm which enables new methods and opportunities that could not exist under the current regime. If the value is moved from the final product to the EDL then access to the content becomes a potential for separate revenue streams. As discussed above, rather than take the financial risk of selling a single product such as a movie, a content provider can mitigate its risks and increase its profits by distributing EDLs to a thousand directors so that they can create a thousand movies. The consumers of those thousand movies must then come to the content provider to access the content in order to assemble the final product.

The Editor

The editor is the creator of the EDL. In one embodiment of the present invention, an editor is an author, musician, director or other type of content provider. According to another embodiment, the editor is not a content provider but creates the EDL in association with or perhaps even at the direction of a content provider. According to another embodiment, the editor is a third party who is not connected to the content provider. According to another embodiment, a consumer can modify an EDL and become an editor. According to another embodiment, a consumer who modifies and EDL and thus becomes an editor can distribute their amended EDL to other consumers, who can, in turn, become editors. The discussion herein assumes that the editor is also the owner and provider of the EDL, however, a worker skilled in the art will appreciate that the EDL could be distributed by a third party separate from the editor without departing from the general scope and nature of the present disclosure.

In order to create the EDL, the editor will require access to content. According to one embodiment, the editor is also the content provider and has created the content referenced in the EDL. According to another embodiment, the editor has been granted access to content by a content provider.

The Content Provider

The content provider controls access to source content. According to an embodiment of the present invention, the content provider is the original owner of rights to the content, for example an actor, author, photographer or musician. According to another embodiment, the content provider has had rights to various content assigned or licensed to it, such as for example, a media production company. According to another embodiment, a content provider is an agent or trustee authorized to grant licenses to use source content on behalf of the owner such as, for example, a collective rights management body or agency. In another embodiment, the consumer owns the content referenced by the EDL or a copy thereof, entirely or in part, thereby constituting a content provider for that contributed content. According to another embodiment, a single EDL can reference content owned by more than one content provider. A worker skilled in the art will appreciate that the present invention creates a market environment which can lead to new types of content providers that do not exist in the current market environment.

According to an embodiment of the present invention, the content provider is a separate entity from the editor. In another embodiment, the content provider and the editor are the same entity. In another embodiment, the content provider and the editor have a pre-existing relationship. Such a relationship would facilitate consumers' access to content described by an EDL as access could be negotiated or paid for in conjunction with access to the EDL. In another embodiment, the editor and content provider have no relationship and the consumer must negotiate access rights to the EDL and the content separately. In the event that the consumer is also a provider of content, access to this content is available from either the consumer's own computing device, or a device related thereto and in communication therewith, or stored and accessible from a remote repository from which the content may be accessed by the consumer when needed.

The Consumer

The consumer is any person not presently included in the EDL process, such as an end user, as well as other consumers such as distributors, value added retailers (or other types of VARs), optional service providers, advertisers, agents and the like, who wish to access the EDL in order to create a final product for their personal use. In one embodiment, the consumer accesses the EDL in order to create a final product for reasons other than their personal use, such as, for example, sale, distribution, rental or the like. In one embodiment, the consumer is an individual or end user using a computing device to access and process an EDL and content. In another embodiment of the invention, the consumer can also modify an EDL and take on the role of an editor.

According to one embodiment, the consumer uses one or more computing devices in order to obtain, view, process and/or modify an EDL. In general, such a computing device may generally comprise one or more machines that would be understood by a worker skilled in the art to include any electronic device capable of and with sufficient storage and computing capability required to access various content sources, interpret and perform the instructions contained within an EDL so as to produce a final product, and to view said final product. Examples of computing devices may include, but are not limited to electronic devices such as computers, laptops, electronic handheld devices, cellular telephones, smart phones, personal digital assistants (PDA) and the like.

According to one embodiment, the computing device would also be understood to comprise one or more communication devices and/or interfaces with which to communicate with other computing devices, or external devices where required. The communication means would be understood by a worker skilled in the art to include any necessary elements of hardware and, including, but not limited to, communication ports, wireless transmitter/receivers, wires or fiber optics; and software that allow a computing device to exchange data packets with another computing device via such hardware elements.

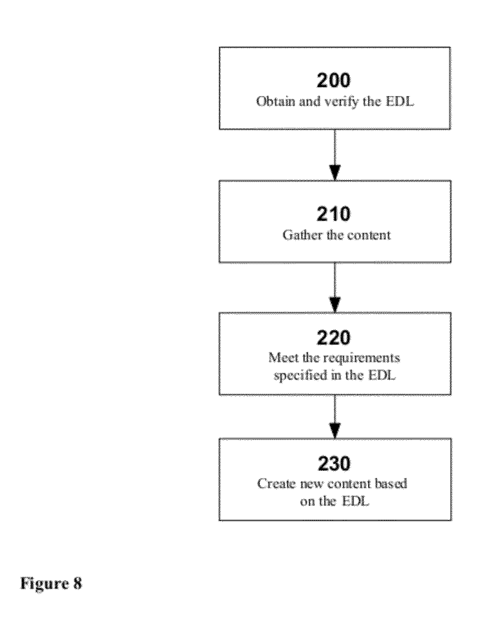

Once the consumer has gained access to an EDL, the consumer then uses one or more computing devices or instructs a service provider implementing system to perform the actions described within the EDL to create a final product. With reference to FIG. 8, there is provided an overview of the main stages required in order to create a new product using an EDL. A worker skilled in the art will appreciate that the order of the steps need not necessarily be carried out in the order specified below for the invention to function.

With reference to FIG. 8, the first step 200 occurs when a consumer obtains an EDL. According to an embodiment of the present invention, the EDL is obtained from a service provider. In one embodiment of the present invention, the EDL is transmitted to the consumer electronically, for example via email, via a download from a website, or via a network such as a peer-to-peer network. According to another embodiment of the invention, the EDL is transmitted to the consumer physically, for example via the transfer of the EDL saved onto a physical media such as a CD, diskette or other storage media. A worker skilled in the art will appreciate that the transfer of the EDL can be managed through a variety of means without departing from the scope of the present invention. In one embodiment of the present invention, the transfer process also involves a verification step to ensure that the EDL is formatted such that it can be interpreted and used by the consumer, that the EDL came from the proper authority, or that the consumer is entitled to access the EDL. In one embodiment, the validation process comprises the step of verifying that all the specifications of the EDL can be met by the consumer's computing device. For example, this process would ensure that any special effects required by the EDL can be performed by the consumer's computing device, and that the final content can be produced and displayed based on the instructions of the EDL.

The next stage in the process, 210 involves the consumer collecting the one or more content sources defined within the EDL. According to one embodiment of the present invention, the collection process is performed automatically using instructions encoded into the EDL itself. According to one embodiment, the EDL comprises instructions that can be interpreted by a computing device that direct the computing device to access content sources via the internet. A worker skilled in the art will appreciate that various types of code-based instructions could be used to accomplish the process of content collection such as java, javascript, html, xml and others. According to another embodiment, the content sources are provided to the consumer on one or more storage media such as CDs or DVDs. The EDL would contain instructions directing the computing device to access the content sources on the storage media. In another embodiment, the EDL contains instructions directing the computing device to first search its internal memory and hard disks for specific content sources and then to access content sources located externally to the computing device. In another embodiment, the EDL directs the computing device to access an online resource where access to content sources can be negotiated separately. In another embodiment, the EDL directs the consumer to consult an online resource such as a website, containing a list of content sources.

In step 220, the EDL instructs the computing device to ensure that all the requirements specified in the EDL have been met. Criteria for verification can include access to the necessary content, and the ability of the computing device to carry out the instructions contained within the EDL. According to another embodiment, this verification step can also include ensuring that the consumer has accepted the necessary terms and conditions needed to use the EDL or that the consumer fits a particular set of criteria for the particular EDL. This criteria could include, age, country of residence, language and so forth. According to another embodiment of the invention, more specific criteria can be provided by the consumer.

Once the EDL has been verified and content sources have been collected, in step 230, the final product can be created and customized according to the instructions contained in the EDL. At this point, the final product can be viewed, listened to, or read by the consumer.

According to one embodiment, the consumer has access to make modifications to an EDL and therefore take on the role of an editor. If the consumer/editor then distributes or provides access to the resulting modified EDL, the consumer can then take on the role of a service provider as well.

According to one embodiment, the consumer applies the EDL to content that they already own or have access to, for example audio CDs and films on DVD. In this embodiment, there is no need for an external content provider to provide access in order for a final product to be created.

Service Provider (Optional)

According to an embodiment of the present invention, an optional service provider controls access to the EDL by the consumer and distributes the EDL to the consumer. According to an embodiment of the invention, the process of distribution is carried out via the internet. The service provider makes the EDLs available to consumers by means of a website. According to another embodiment of the invention, the website allows consumers to download the EDLs directly. According to another embodiment, the service provider's website allows consumers to browse through descriptions and prices of EDLs. The consumer then purchases the EDLs and downloads them. According to another embodiment, the service provider's website provides descriptions and short excerpts of the final product, such as previews of video content, or short samples of audio content for consumers to view before deciding to request the EDL.

According to an embodiment, the service provider is also the editor. In this embodiment, the service provider has either created an EDL according to the steps outlined herein, or has been granted access to modify an existing EDL.

According to another embodiment, the service provider is the content provider. In this embodiment, the EDL has been created by an editor who has either transferred or licensed rights in the EDL to the service provider/content provider. Since the content provider stands to profit from the distribution of EDLs which reference content that it owns, it would make sense for the content provider either to become a service provider, or to encourage editors and service providers, through monetary incentives, access to content or other means.

According to another embodiment, the service provider is neither the content provider nor the editor. In this embodiment, the service provider has obtained rights to distribute an EDL and may also have obtained rights to provide access to the content referenced by the EDL. Such a situation would enable the service provider to become an intermediary and could provide greater ease of use for the consumer who otherwise would need to negotiate access to both the EDL and the necessary content. In this embodiment, the service provider becomes an enabler of the system and can act as a catalyst to allow relationships to form between content providers and editors who might not otherwise be willing to participate in the system.

Commercialization of Edit Decision Lists

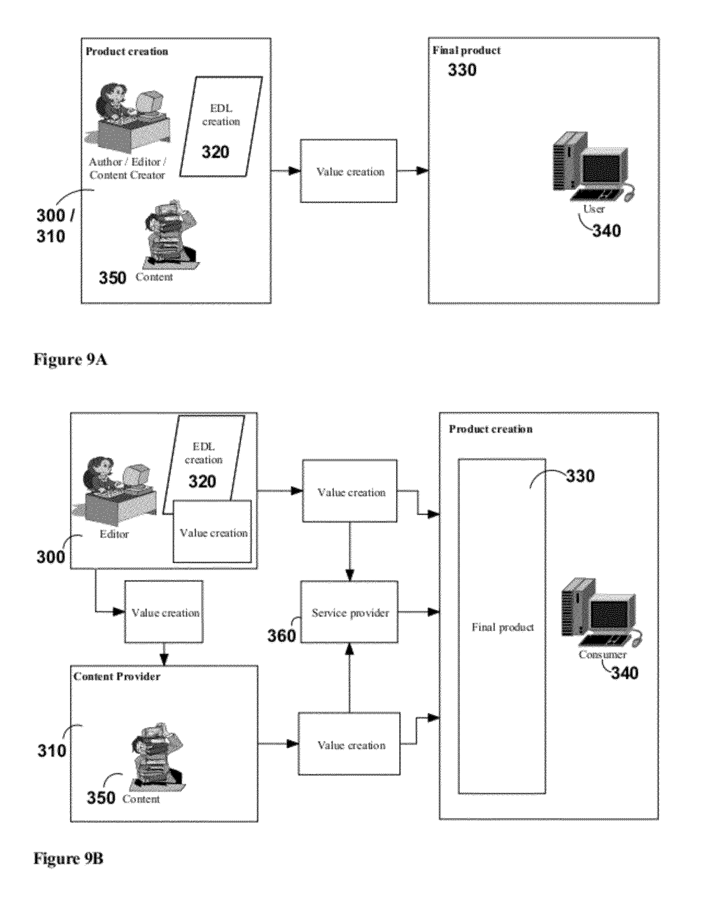

Commercialization of EDLs is effected through granting access to EDLs separate from the underlying content or the final product. In this model, the value shifts to the EDL itself rather than the final product. FIGS. 9A and 9B illustrate the difference between creating value based on the production and distribution of the final content, and based on the creation and distribution of the EDL itself. FIG. 9A shows a traditional business process where the value is obtained after the final product 330 is created. All aspects of the creative process, namely content 350 availability, the editing process performed by the editor 300 and the use of the EDL 320, reside with the content provider 310. The consumer 340 is merely a consumer and has no ability to access either the original content or the EDL. The value within this traditional process resides in the sale, rent, lease or distribution of the final product to the consumer.

With reference to FIG. 9B there is presented a system according to the present invention. This system revolves around the creation, distribution and modification of the EDL 320 itself. As depicted in FIG. 9B, the editor 300 creates an EDL 320 that references content 350 owned by the content provider 310. The creation of the EDL requires some contact between the editor 300 and the content provider 310 At this point, the EDL and content can be distributed to the consumer 340 in several ways. According to one embodiment, the editor 300 and the content provider 310 provide an EDL 320 and content 350 to the service provider 360. The service provider 360 provides the EDL 320 and the content 350 to the consumer 340. According to another embodiment, the editor 300 acts as a service provider and provides the EDL 320 directly to the consumer 340 who then must obtain the content 350 from the content provider 310. The consumer 340 then manipulates the content 350 according to the instructions contained within the EDL 320 to assemble the final product 330.

As demonstrated in FIG. 9B, there are different commercialization methods which can be applied to various points in the overall process that depend on the roles performed by the various parties involved. Thus, a variety of different combinations are possible within this context, differing mainly in how value, for example, money, rights of use, or opportunity to present a marketing message (advertising) to the consumer can be generated and accounted for.

There are four general classes of ways to commercialize distribution of, or granting access to, EDLs or to content. The central thread that works through the three classes is the concept that the EDL is considered to be a marketable product in and of itself, rather than merely a means to the end of producing a final product.

Class 1—Providing Access

The most direct method of commercializing the distribution of EDLs according to the present invention is the direct provision of access to the EDL, the content or both.

According to one embodiment of the present invention, a service provider provides access to one or more EDLs to a consumer. According to one embodiment, access to the EDL is permanent. According to another embodiment, access to the EDL is granted on a temporary basis. A worker in the art would appreciate that the EDL can be made available to consumers in a variety of ways. According to one embodiment, the EDL is made available through a website where users can browse through descriptions of various EDLs, and can purchase and download the EDL via the internet. In another embodiment, the EDL is encoded onto a storage medium such as a CD and is physically transferred to a consumer. This means of transporting the EDL has the advantage of not requiring an internet connection and could allow the content source to be packaged along with the EDL for ease of use.

According to one embodiment of the present invention, a service provider who is also an editor can create customized EDLs to produce individual versions of a final product for each consumer. According to one embodiment, an editor/service provider creates customized versions of content in response to information provided by the consumer, for example through a questionnaire on a website. Types of criteria that could be used to generate different versions of final products could include, for example, language, suitability for different age groups, length and genre.

In one embodiment, the service provider provides access to a variety of different EDLs in a database that can be selected according to information provided from a consumer. According to another embodiment, EDLs are generated individually by an editor/service provider, in response to requests and information from a consumer. According to another embodiment, EDLs are modified automatically by a computing device in response to information provided by a consumer according to a pre-programmed set of instructions contained within the EDL.

According to one embodiment of the present invention, specific functions such as advertising or targeted inclusion or exclusion of content can be entered explicitly into the EDL to create customized final products. For instance, versions of the final product can be created to uniquely appeal to different demographic groups. Other types of functions could be software instructions that will require external inputs to trigger actions during the creation of the final product.

According to one embodiment, different EDLs or different versions of an EDL can be assigned different monetary values by a service provider. Value can be assigned, for example, based on the complexity of the instructions, number of content sources referenced, or the popularity of the EDL relative to other EDLs.

According to one embodiment, the service provider generates profit by exchanging access to content for valuable consideration. According to another embodiment, the service provider allows consumers to download copies of content. According to another embodiment, content is saved on a storage media such as a CD and physically transferred to a consumer. According to another embodiment, consumers only access specific content designated by an EDL. According to another embodiment, access to content is provided on a temporary basis and the consumer does not keep a copy of the content or the final product.

According to another embodiment, editors can access and browse through all content owned by a content provider and choose specific parts of content that they wish to reference in an EDL. According to another embodiment, the content provider provides access to two versions of the same content, low and high quality. The low quality content could, for example, be made available for access at a reduced price to allow editors to make EDLs. The EDLs are then provided to consumers and a service provider provides consumers access to the high quality content for an increased price.

According to one embodiment, the price charged for access to content could vary based on the quantity of content being accessed. For example, a service provider could charge a flat fee based on the number of tracks, or seconds of content accessed. Other options for pricing could include monthly fees for unlimited access to content. According to another embodiment of the present invention, content can be priced according to the artist or artists involved in generating it. For example, video content produced by a well-known director could be priced differently than content produced by an unknown director. According to another embodiment, editors are not charged for access to content but consumers using an EDL to create a final product are charged. According to another embodiment, editors and consumers are not charged for access to content and the consumer is merely buying access to the EDL.

According to one embodiment, the editor and content provider have a business relationship with a third party service provider in which the price for access to content referenced in an EDL is pre-negotiated before the EDL is distributed. In this embodiment, a consumer would pay a single price to access both the EDL and the content the EDL references. This would simplify access from the consumer's point of view, which could make the EDL more desirable.

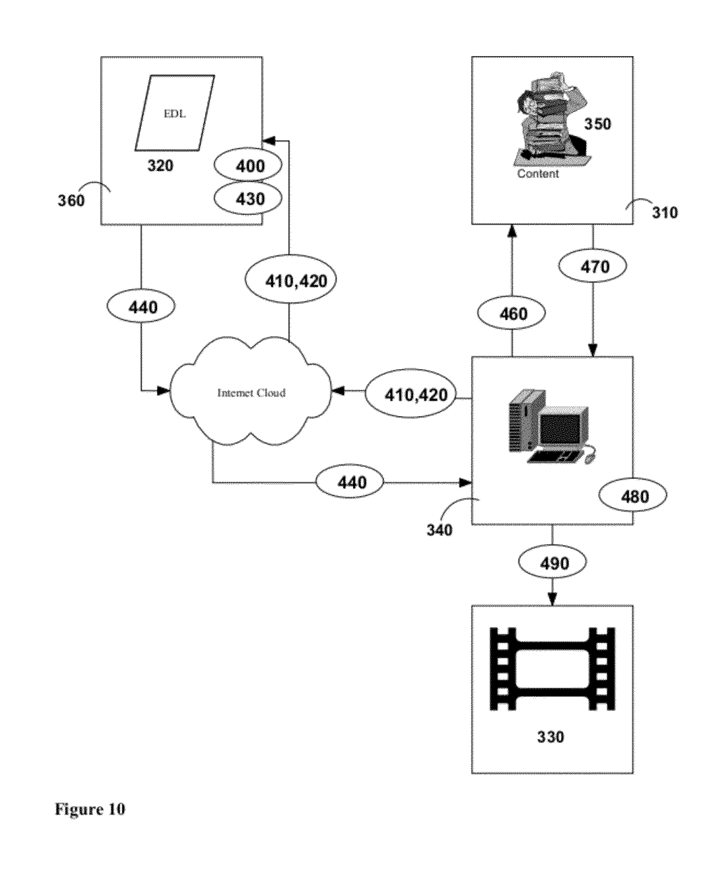

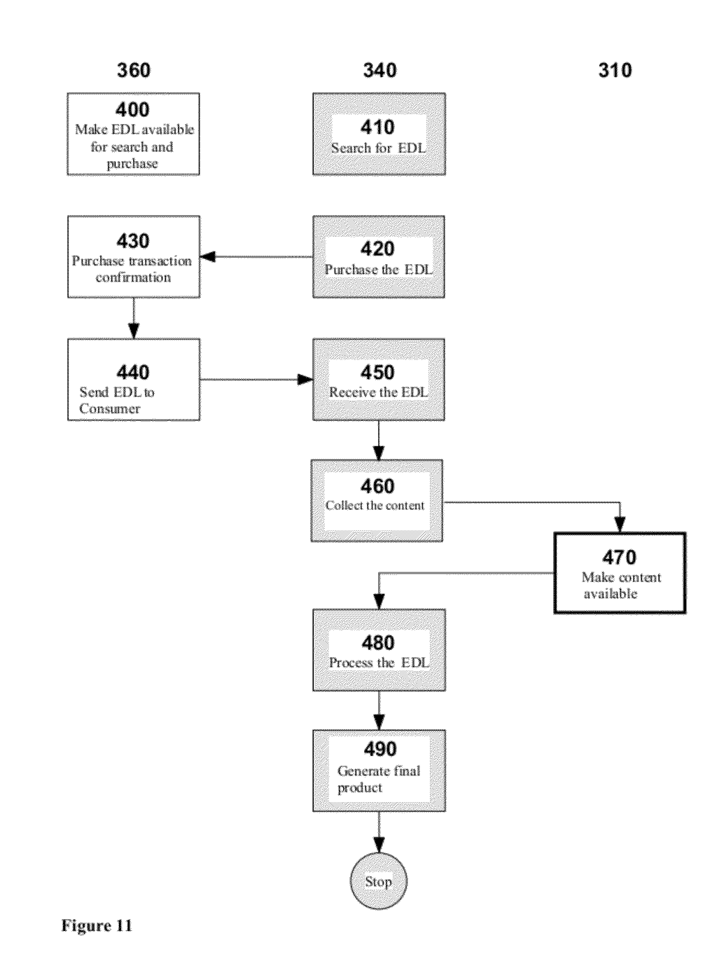

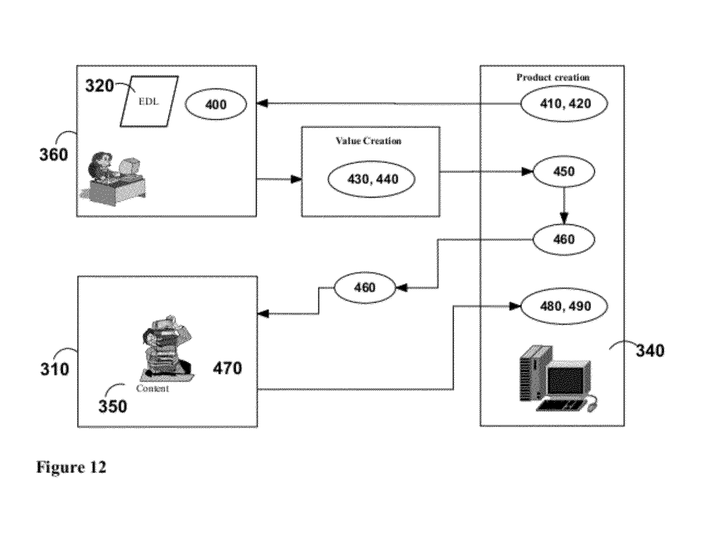

According to an embodiment of the present invention, a service provider makes an EDL available for purchase by consumers. According to another embodiment, access to content sources is also provided by the service provider as part of the price of the EDL. According to another embodiment, access to content sources is negotiated separately between a different service provider and the consumer. An illustration of this concept is provided in FIGS. 10, 11 and 12. FIG. 10, is a graphic representation of the process of purchasing an EDL and combining it with content to produce a final product. FIG. 11, breaks this process down into steps. FIG. 12 is a representation of the same process as in FIGS. 10 and 11 and identifies where value is created.

With reference to FIGS. 10, 11 and 12, in step 400, the service provider 360 makes an EDL 320 accessible for queries and purchase via the internet. For example, the service provider can store a description of the EDL in a database accessible over the Internet. In steps 410 and 420, the consumer 340 who is interested in the new final product 330 that the EDL 320 can generate purchases the EDL 320 from the service provider 360. The consumer has discovered the EDL after performing a search, for example, by accessing a website through the Internet, or by other means of locating a particular EDL. Once the consumer finds the EDL, he or she goes through a purchase process to secure the rights to use the EDL. This purchase process does not necessarily have to involve a monetary transaction between the consumer and the service provider. For example, in an advertising business model, a third party content provider (the advertiser) could pay the service provider for the opportunity to interact with the consumer when the consumer requests the EDL. In step 430, the service provider 360 authenticates the order and confirms the transaction. In the case of an advertising business model, the consumer's order for an EDL represents an expression of interest: an advertiser will pay the service provider for the opportunity to interact with the consumer. With regard to FIG. 12, it is step 430 wherein value is created in the EDL 320. After confirming the transaction, the service provider 360 ensures that the consumer 340 can access the EDL 320 and, in step 440 delivers the EDL 320 to the consumer 340. The delivery system can vary. For example, in a web-based system, the consumer can download a file containing the EDL. In an e-mail based system, the service provider can send the EDL as an attachment in an e-mail. In a document based system, the EDL can be sent thorough the mail. In step 450, the consumer receives the EDL 320, the form of which will be dependent on the method of delivery. For example, for a web-based system, the EDL will be a computer file. In a document-based system, the EDL can be a printed series of instructions.

In steps 460 and 470, the consumer 340 requests and receives the content 350 referenced by the EDL 320. According to an embodiment of the invention, the consumer 340 retrieves the content 350 actively. For example, the consumer locates and if necessary, purchases the content 350 required by the EDL 320 from a content provider 310. According to another embodiment, the consumer can gather the content passively. According to one embodiment, included in the EDL 320 is a description of how to access the referenced content 350 and that content 350 can be retrieved automatically by the consumer's computing device. In order to enable this process, the content provider 310 must make the content 350 available. The consumer 340 may also be a content provider 310 as they may already have the necessary content on, for example, Digital Video Disc (DVD), Compact Disc (CD) or tape. In step 480, the consumer 340 receives all the required content 350 and follows the instructions specified by the EDL 320. The execution of the instructions could be achieved manually or through a computing device that contains a common editing program that understands the instructions specified in the EDL. In step 490, the consumer 340 creates the final product 330 by following the instructions on the EDL.

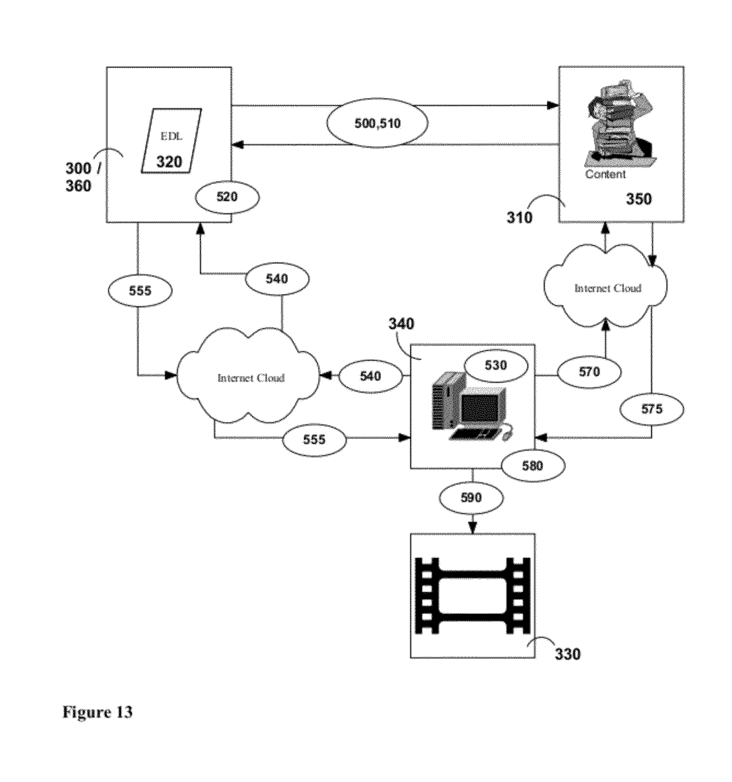

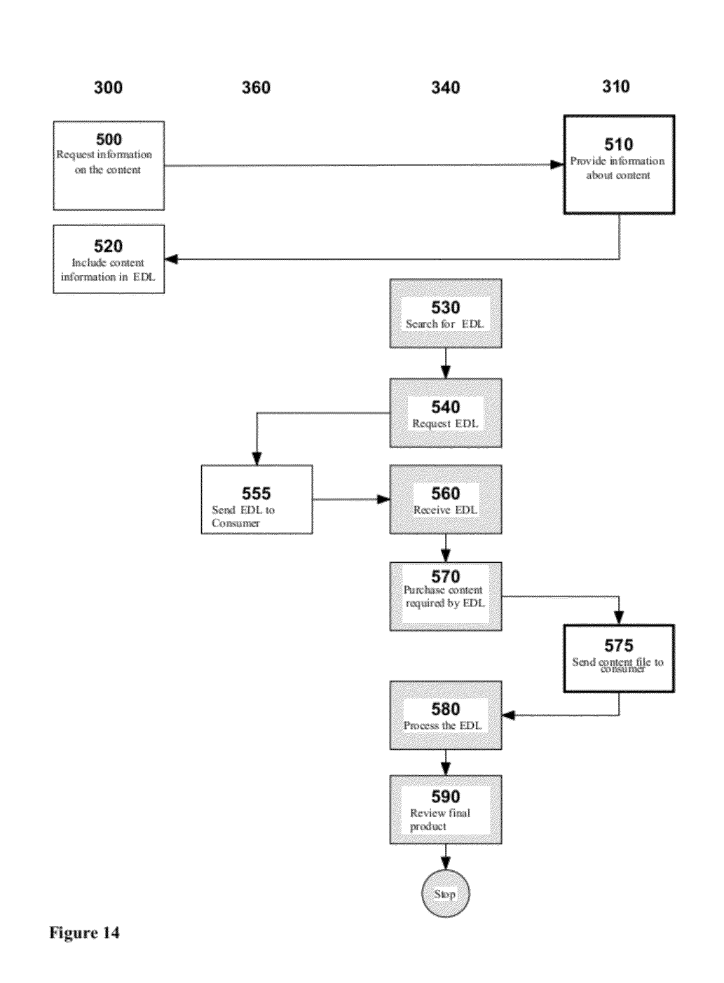

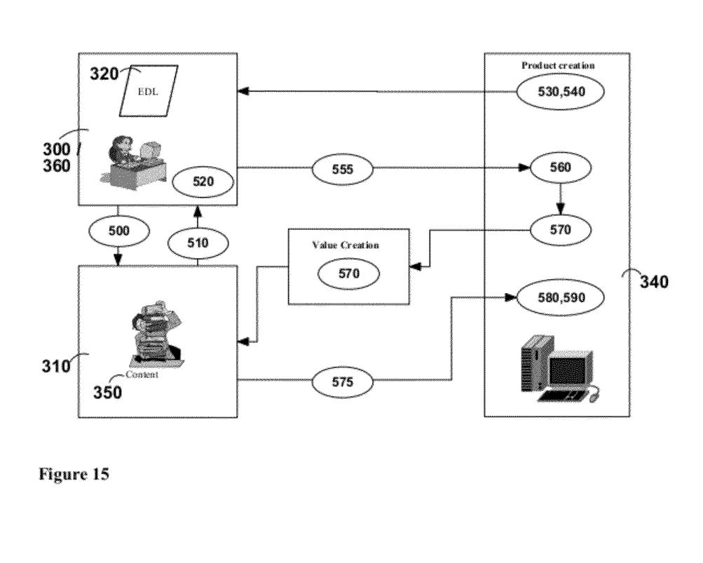

According to an embodiment of the present invention, a service provider makes content available for purchase by consumers. An illustration of this concept is provided in FIGS. 13, 14 and 15. In FIG. 13, there is provided a graphic representation of the process of buying and selling access to an EDL and content, wherein the EDL can be used to direct a consumer to the necessary content source required to generate a final product. In FIG. 14, there is provided a diagram of the steps of the process represented in FIG. 13. FIG. 15 is a representation of the same process as in FIGS. 13 and 14 and identifies where value is created.

With reference to FIGS. 13, 14, and 15 in step 500, an editor 360 obtains information from the content provider 310 on the availability of the content 350 referenced in an EDL 320. Other types of information that could be obtained from the content provider/service provider 362 include the price of the content 350, its mark-up, and the purchase method for the content. In step 510, the content provider 310 provides information on how the content 350 is to be purchased and distributed. For example, the content provider 310 can specify that the content 350 should be purchased directly from the content provider 310, or that the content 350 can only be used under the terms of a specific licensing agreement. In step 520, the editor 300 incorporates this information into the EDL 320. A service provider 360, who could also be the editor, then makes the EDL 320 available for search and purchase. The service provider 360 and the content provider 310 could also be the same or separate entities. One requirement is that the service provider 360 has information on the location of the content 350 required for the EDL 320 and how to obtain that content 350. In step 530, a consumer 340 searches for the EDL 320 by accessing a website or a database listing the EDL (not shown). In step 540, consumer 340 requests the EDL 320 from the service provider 360. In step 555, the service provider 360 receives a request for an EDL 320 from a consumer 340 and then sends the EDL 320 to the consumer 340. In step 560, the consumer 340 receives the EDL 320 and begins processing the instructions contained within it. In step 570, the EDL 320 triggers a prompt that directs the consumer 340 to purchase the content 350 in order for the EDL 320 to be processed. Also in step 570, using the information provided by the EDL 320, the consumer 340 pays for the content 350 required by the EDL 320 from the service provider 360, or, with reference to FIG. 13, from the content provider 310 who has taken on the role of a service provider 360. After receiving payment, in step 575 the service provider 360 sends the content files 350 to the consumer 340. For example, the consumer can download the required source files over the Internet. With reference to FIG. 15, it is in step 570 that the value is created. Alternatively, the source files can be available in other formats such as Digital Video Discs (DVD), or Compact Discs (CD). In step 580, the consumer 340 can proceed with instructions contained in the EDL 320 after receiving the various content files 350 and generates the final product 330. In step 590, the consumer 340 reviews the final product 330.

According to an embodiment of the present invention, customized EDLs can be provide to produce final products targeted at specific segments of the market. The process begins with the editor determining that a target market for a final product can be segmented according to defined criteria. For example, an editor may wish to display the final product for a multi-lingual audience, and requires the same content to be translated into English, French, and Chinese. Other criteria for market segmentation can include but are not limited to age, gender, education level, geographic location, time and the like.

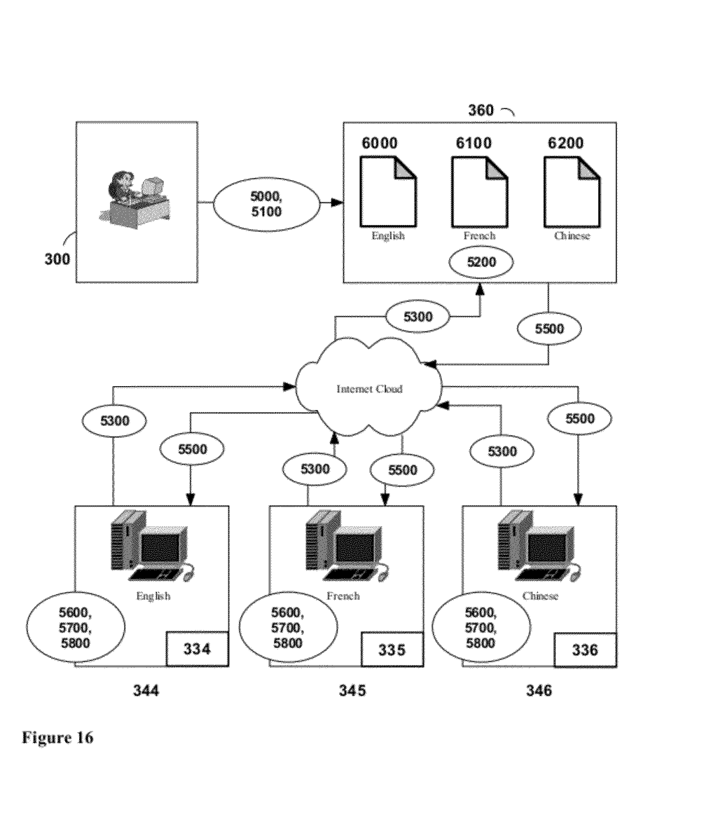

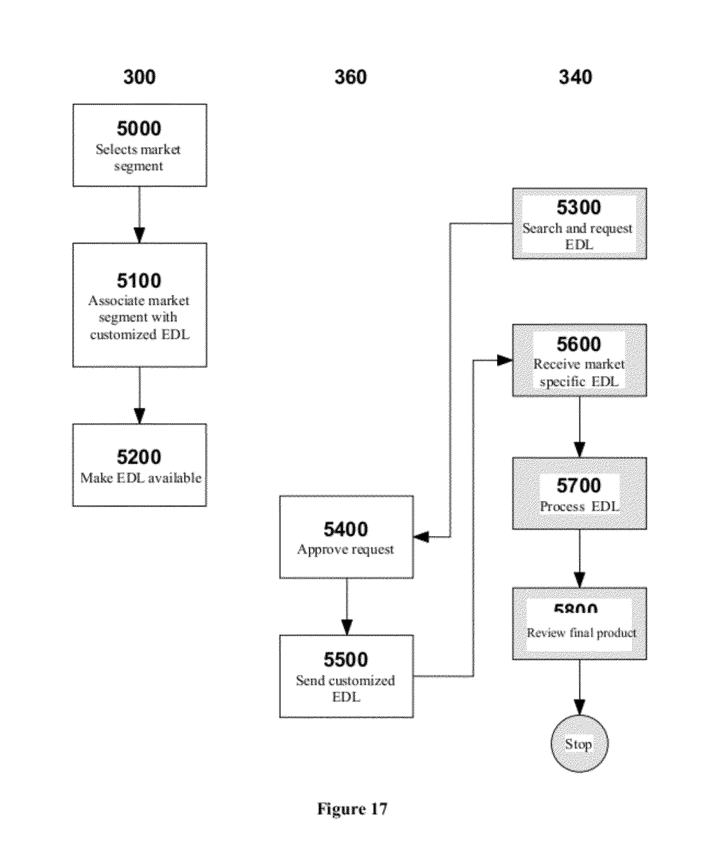

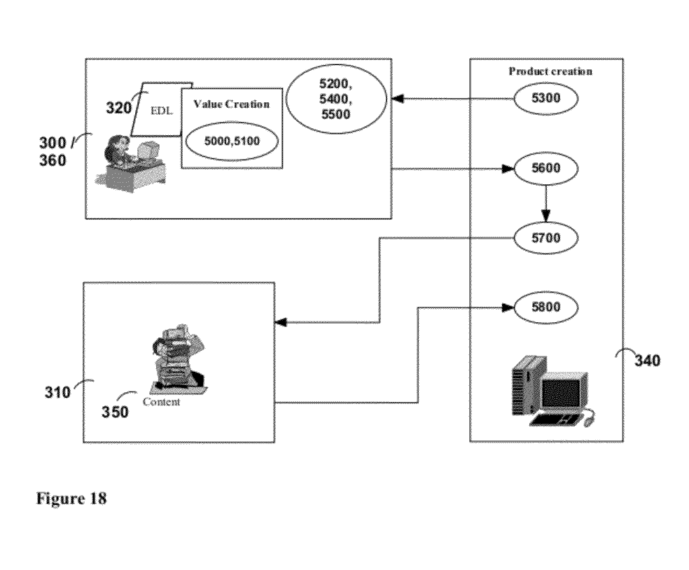

An illustration of this concept is provided in FIGS. 16, 17 and 18. FIG. 16 is a graphic representation of the process of making and providing access to customized EDLs. FIG. 17 is a process diagram of the process illustrated in FIG. 16. FIG. 18 is a graphic representation of the process provided in FIGS. 16 and 17 highlighting the step in which value is created.

With reference to FIGS. 16, 17 and 18, in step 5000, the editor 300 selects different market segments that he or she wishes to target. In step 5100, the editor 300 creates a series of modified EDLs 6000, 6100 and 6200 to satisfy the demands of different market segments. For example, the changes to each EDL could be as follows:

a. English market segment 6000
i. Change all dialogue to English
ii. Change all visual signs in the final content to English

b. French market segment 6100
i. Change all dialogue to French
ii. Change all visual signs in the final content to French

c. Chinese market segment 6200
i. Change all dialogue to Chinese
ii. Change all visual signs in the final content to Chinese

A worker skilled in the art will appreciate that the process of changing visual signs into different languages could be accomplished either through digital alteration or by selecting different content elements. For example, a content provider could perform digital alteration on video content to create multiple versions of the same content elements in different languages.

With reference to FIG. 18, it is step 5100, in which the individual EDLs are created, which creates value.

In step 5200, once the EDL is created, it is then made available to consumers through a service provider 360. In step 5300, consumers 344, 345 and 346 from particular market segments request and receive the appropriate EDL 6000, 6100 or 6200 and generate the desired final product 334, 335 or 336 using the customized EDL 6000, 6100 or 6200.

The concept of building EDL value through market segmentation and the creation of customized EDLs can be extended to creating one unique EDL for each individual consumer. A unique and individual EDL will create a final product that is unique to the consumer. An example of this type of systems is as follows.

In the first step in the process of enabling the creation of unique EDLs, the editor decides that each consumer should receive a unique version of the final content. The editor may wish to have a unique version for any number of reasons; for example, to allow the editor or a service provider to identify and control each version of the final content created by the unique EDL.

The editor creates criteria for customizing the EDL which will lead to changes in the final product once the instructions of the EDL are executed by a consumer. Examples of criteria for customization that lead to a unique final product include:

a. Placing unique identifiers such as watermarks in random content elements during the execution of the EDL;

b. Using random sizes for some content elements to create an unique product signature;

c. Changing the properties such as lighting or object placement within content elements.

Once the customizable EDL has been created, the service provider makes it available to consumers. The service provider can then generate a unique EDL for each consumer based on the defined criteria of customization. The consumer then receives and follows the instructions provided by the EDL to create the final product.

According to another embodiment of the present invention, information supplied by the consumer or supplied by external processes is used to generate a particular final product. According to one embodiment, this type of interactive EDL is achieved by embedding within the EDL one or more sets of rules that can determine the form that the final product will take. For example, before the final product is generated, a set of instructions contained within the EDL prompt the consumer to answer a series of questions, as specified in an input function. The editor determines the input functions, the associated rules and the resulting changes in execution of the EDL. An input function represents feedback from the consumer or an external agent (for example, system information on a computing device or a third party). Associated rules are invoked in response to the input functions and the results of the rules are expressed in the final product.

Examples of interactive content could be as follows: the input function is the consumer's age. If the age is less than or equal to 18, the computing device uses the appropriate rules within the EDL to create a final product based on a pre-defined “family edit”. If the age is greater than 18, the computing device uses the appropriate rules within the EDL to create a final product based on a pre-defined “restricted edit”. Another example would be the system date of the computing device executing the instructions on the EDL. If, for example, the system date is greater than or equal to 2006 (i.e. the system is at least as old or newer than 2006), the computing device is allowed to continue with EDL generation. If the system date is less than 2006 (i.e. the system is older than 2006), the consumer is prompted to contact the service provider for more information, such as an updated version of the EDL. Another example of an input function could be a systems request wherein the computing device is prompted to contact the service provider with an electronic message when generating final product

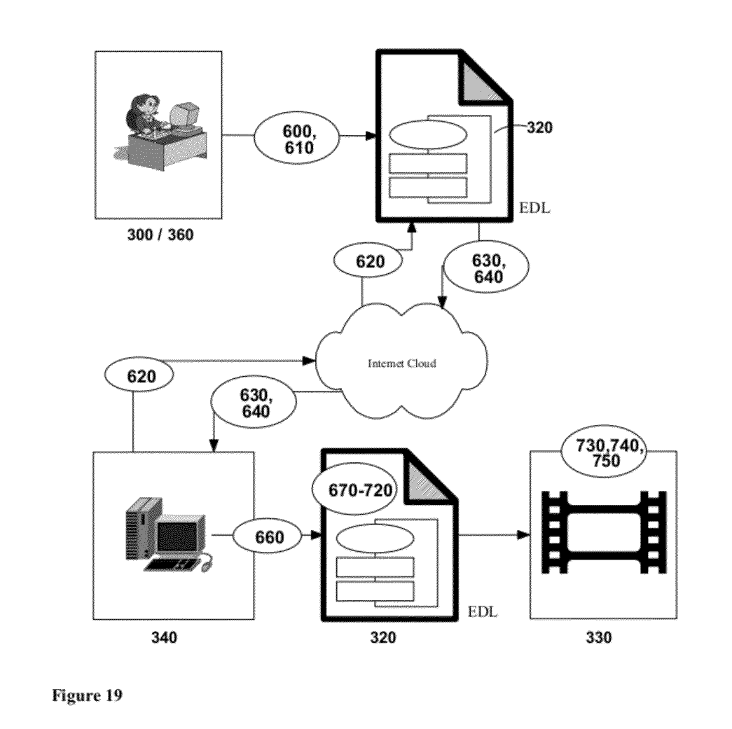

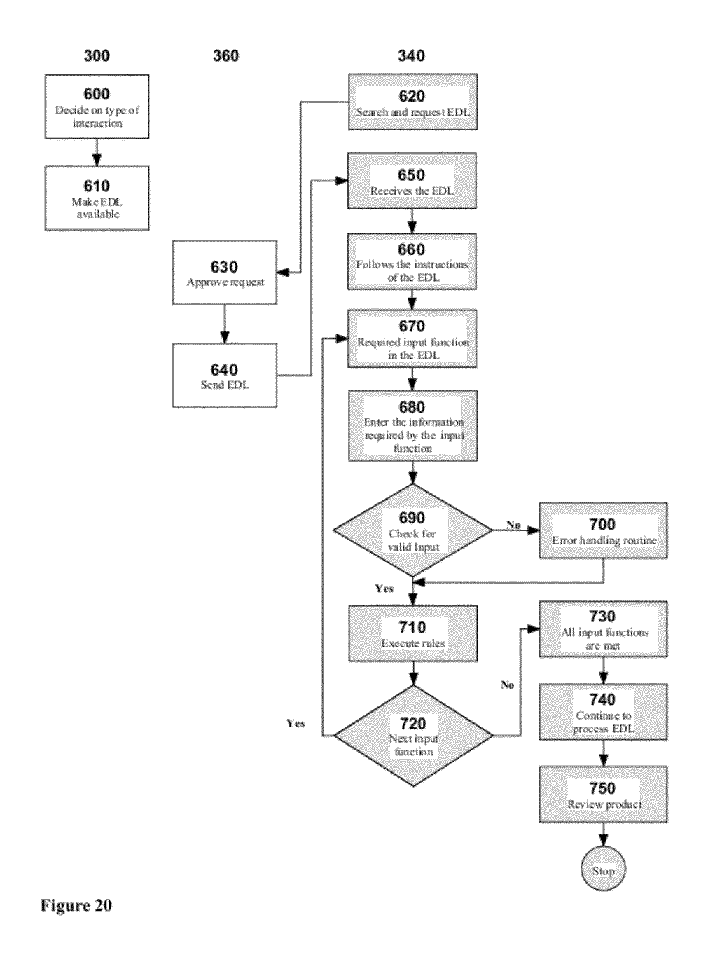

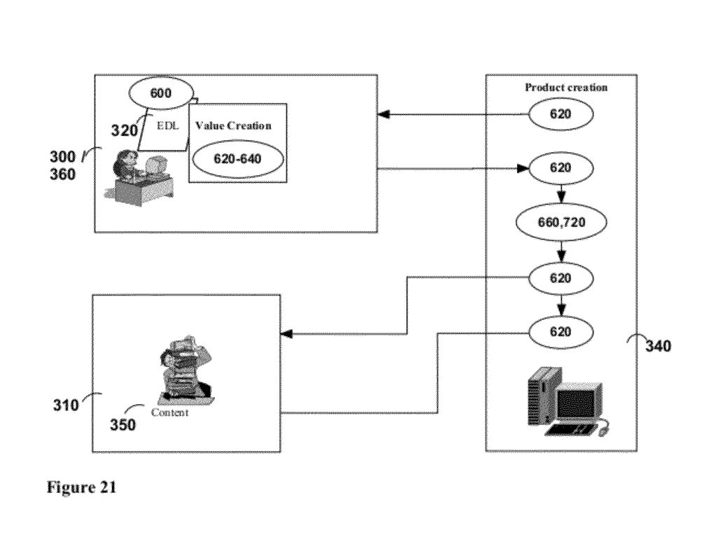

An illustration of this concept is provided in FIGS. 19, 20 and 21. FIG. 19 provides a graphic representation of the process of creating and distributing an interactive EDL wherein the consumer provides input to generate an individualized EDL. FIG. 20 is a process diagram that describes the actions between the editor, the service provider and the consumer with regard to the creation, distribution and use of an interactive EDL. FIG. 21 is a graphic representation of the process represented in FIGS. 19 and 20 indicating where value is created.

With reference to FIGS. 19, 20, and 21 in step 600, the editor 300 creates an interactive EDL 320. The EDL 320 contains rules governing the behavior of the EDL and the inputs required to execute those rules while processing the EDL. In step 610, the service provider 360 makes the EDL 320 available, for example by placing the description of the EDL 320 and the final content in a searchable database accessible over the Internet. In step 620, the consumer 340 searches for an EDL 320 or the final content generated by the EDL. For example, the EDL is discovered through a keyword search via an internet search engine or through a recommendation by a friend. Also in step 620, the consumer 340 requests the EDL 320 from the service provider 360. In step 630, the service provider 360 approves the request for the EDL and, in step 640, enables the consumer 340 to access to the EDL 320. With reference to FIG. 21, value is created in steps 620 to 640. As part of step 640, transfer of the EDL 320 could occur electronically, either as a downloaded file or as an e-mail attachment. In step 650, the targeted consumer 340 receives the interactive EDL 320. An interactive EDL requires additional information during the execution of the EDL to create the final product. In step 660, the consumer starts to process the EDL 320. For the purposes of this discussion, the consumer's computing device manages the processing of the EDL. A worker skilled in the art will appreciate that this processing can be achieved through a software program, a system dedicated to the process of an EDL or even a manual process that can interpret and execute the instructions in the EDL. While executing the EDL, input functions may be encountered. Input functions are additional information required by the EDL. This information can be supplied by the consumer; the consumer's computing device or a third party.

At step 670, the EDL 320 processing starts with a first input function. At step 680, the consumer, the consumer's computing device or a third party enters the information required by the input function within the EDL 320. At step 690, there is an error checking process that ensures that the input data is valid during the execution of the EDL 320. If the input is not valid, at step 700, the EDL instructs the consumer's computing device to implement the appropriate error handling routines that will manage invalid inputs. An example of an error handling routine is to prevent the consumer's computing device from proceeding to process the EDL 320 until the input is valid or to instruct the computing device to use a default value in place of the invalid input. The EDL instructions continue after the error handling routine are completed.

At step 710, the consumer's computing device executes the rule that is associated with the input function when a valid input is received. At step 720, the EDL process continues until the next input function is required. Steps 670 to 720 continue in an iterative manner, creating a cycle of modification to the EDL 320 as it continues to be customized based on the new information that is being gathered. The final content is not generated until all the requirements of the input functions are met at step 730. After all the input functions are satisfied, at step 740, the consumer's computing device continues to process the EDL 320 until the final product is generated. At step 750, the content consumer can review the newly generated product 330.

According to another embodiment, the interactive EDL comprises a number of sublists. Each sublist is an EDL corresponding to a particular final product. When the consumer provides input functions, the resulting rules lead the computing device to select one sublist and to generate the resulting final product.

According to one embodiment of the present invention, the EDL references source content which is accessed as a streaming media. A streaming media by definition can be video, audio, pictures or text that can be transmitted over a network so that the consumer can begin to review the content immediately instead of waiting for the entire file to be delivered. Streaming media is sometimes a preferred means of allowing consumers access to digital media because it does not result in the consumer possessing a copy of the media that they could then make further copies of or distribute. An EDL can be authored for streaming media where the instructions contained within the EDL are executed in real time while the content is being streamed.

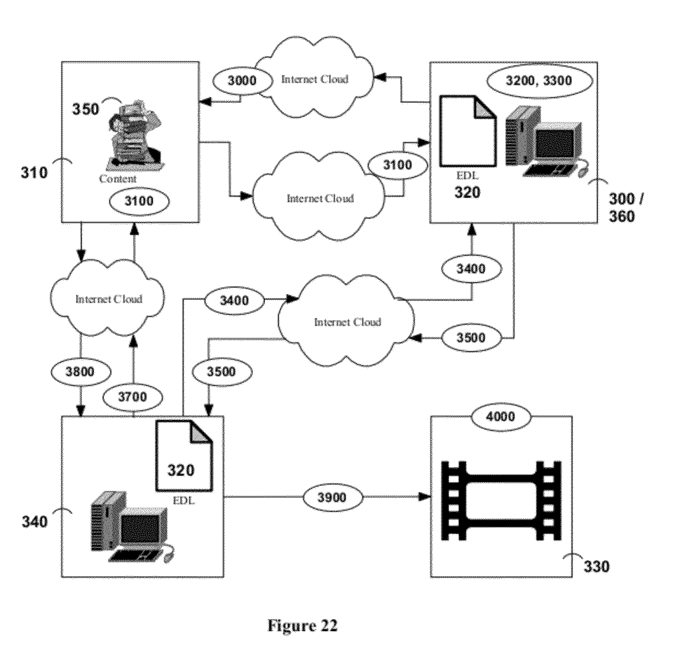

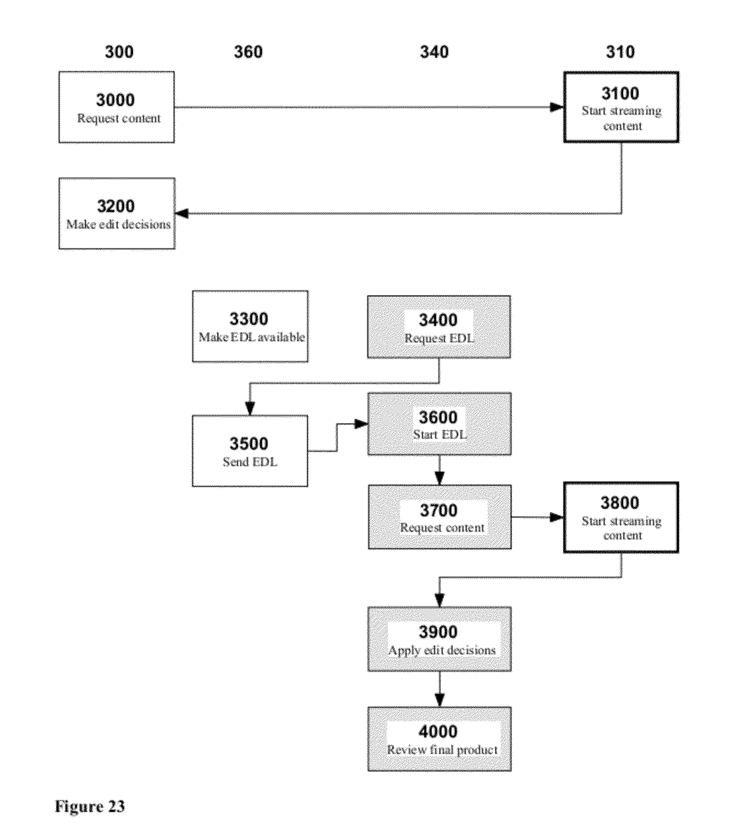

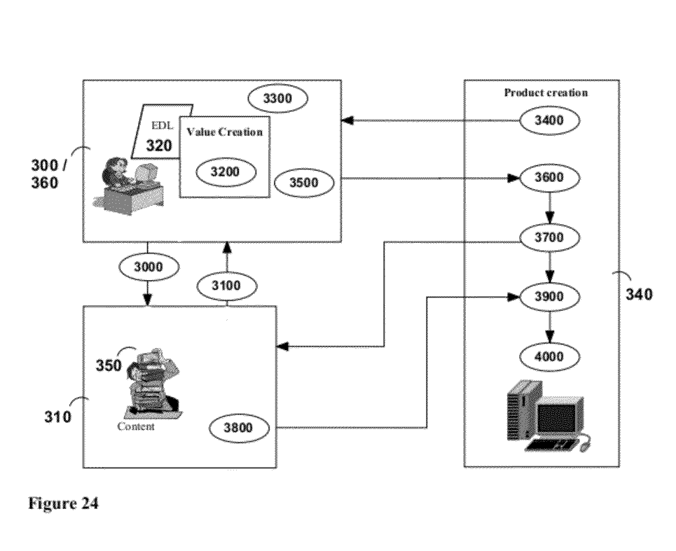

An illustration of this concept is provided in FIGS. 22, 23 and 24. FIG. 22 is a graphic representation of the process of distributing and processing an EDL that references streaming content. FIG. 23 is the corresponding flowchart for the processes described in FIG. 22. FIG. 24 is a graphic representation of the process illustrated in FIGS. 22 and 23 wherein the step in which value is created is highlighted. Although the following discussion considers only a single stream of content, a worker skilled in the art will appreciate that more than one stream of content could be combined into a final product without departing from the scope of the invention.

With reference to FIGS. 22, 23 and 24, in step 3000, the editor requests streaming content 350 from a content provider 310. In step 3100, the content provider 310 starts streaming content based on the request from the editor. For the purpose of this discussion, the content is delivered over the Internet but a worker skilled in the art will appreciate that this process could be applied over any type of network connection such as cable, telephone, computer, or broadcast medium. In step 3200, the editor makes edit decisions and incorporates them into an EDL. With reference to FIG. 24, it is in step 3200, that value is created. According to one embodiment, the editing process occurs as the source data is being delivered and before the complete source content is obtained. This editing process can be repeated to refine the EDL. According to another embodiment, the editor downloads or captures the stream and generates the EDL without the need to repeatedly stream the content. In step 3300 a source provider 360 makes the EDL 320 available to consumers. This could be achieved, for example, by the source provider making the EDL file searchable and downloadable from a website. In step 3400, a consumer 340, after becoming aware of the EDL 320, requests the EDL 320 from the source provider 360. In step 3500, the source provider 360 acknowledges the request from the consumer 340 and provides access to the EDL 320. In step 3600, the consumer 340 starts to process the EDL 320. This could be achieved through a software program, a system dedicated to the processing of an EDL or executed manually by the consumer 340. In step 3700, following the instructions in the EDL 320, the consumer 340 requests the appropriate content 350 that is specified in the EDL 320. In step 3800, the content provider 310 receives the request for content 350 and begins to transmit the content 350 to the consumer 340. In this case, the content 350 is transmitted over the Internet. A worker skilled in the art will appreciate, however, that the idea of streaming can be applied over any type of network connection. In step 3900, the edit decisions are applied as the content 350 that is being streamed according to the instructions of the EDL 320. According to another embodiment, the EDL can incorporate multiple content sources from more than one stream which is being obtained from different content providers at the same time. The edit decisions are being applied as the source stream is arriving. This type of process is distinct from traditional applications of non-linear editing, since EDLs are generally applied after the completed source has been assembled. In step 4000, the consumer 340 reviews the new final product 330 as the content 350 is being streamed and the instructions in the EDL 320 are being executed. Alternatively, the consumer can stored the edited streaming information and review the final product 330 after the EDL list is completely processed.

Class 2—Allowing Modification

According to one embodiment of the present invention, the editor provides read-only versions of the EDL to consumers. Consumers can only view the final product specified by the EDL. According to another embodiment, editors provide read and write access to the EDL, allowing the EDL to be modified by the consumer. By providing this level of access, each consumer of content becomes a potential editor. This access can be priced differently or can be subject to separate negotiation as to how rights in any modified EDLs will be shared between the editor and consumer. From the point of view of the content provider, providing consumers with the ability to modify EDLs is desirable as it increases the potential pool of consumers paying for access to content. Modified EDLs may also appeal to different niches in society who may not have been interested in the product produced by the initial EDL. From the point of view of the consumer, having modified and modifiable EDLs in circulation increases the amount of targeted content that they can purchase. This also allows the consumer the freedom to adjust final products to their own tastes, which may lead them to create new EDLs in the future. According to one embodiment, content providers could encourage the creation of modified and targeted EDLs by rewarding editors with access to content or through monetary incentives.

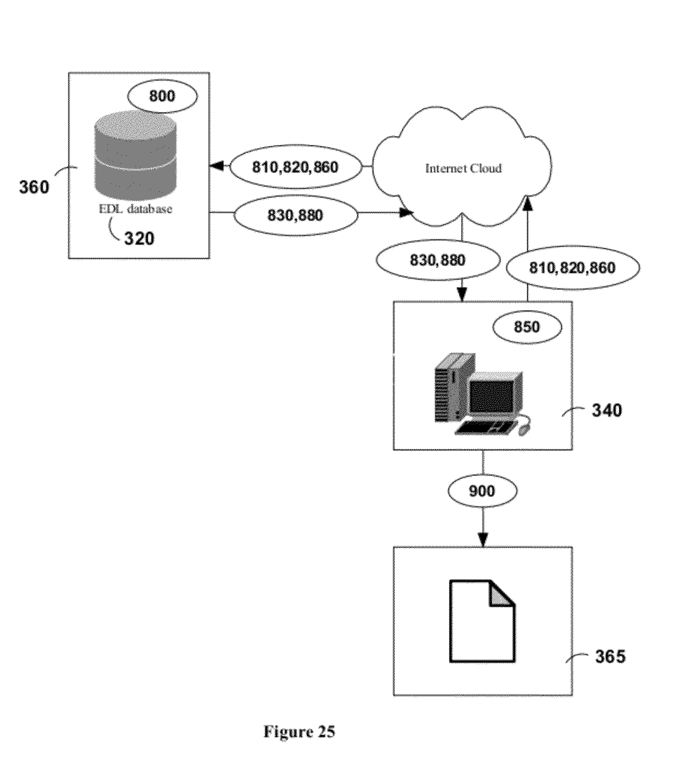

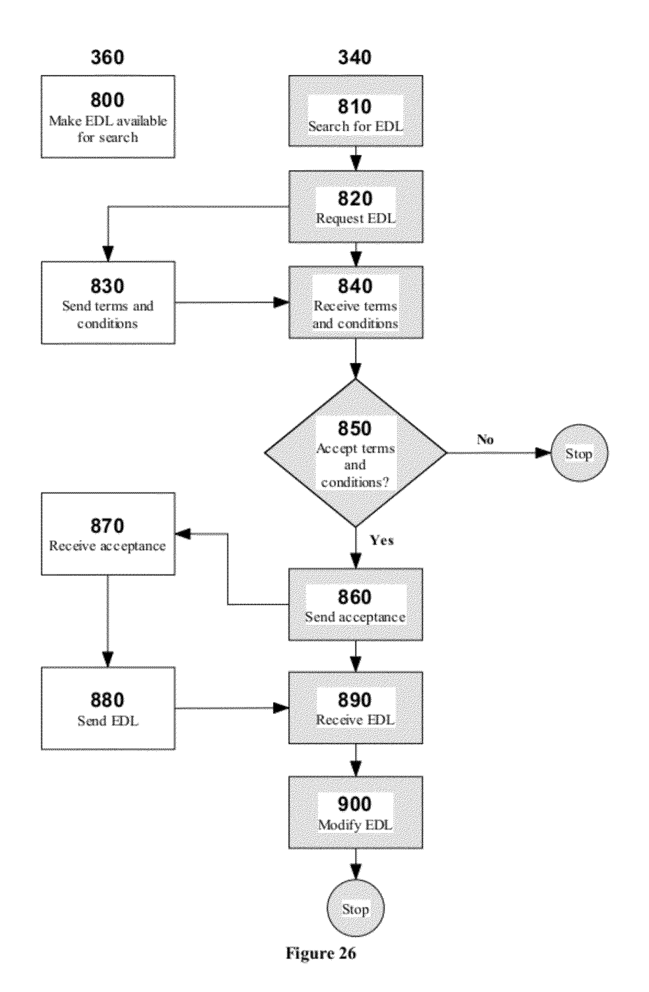

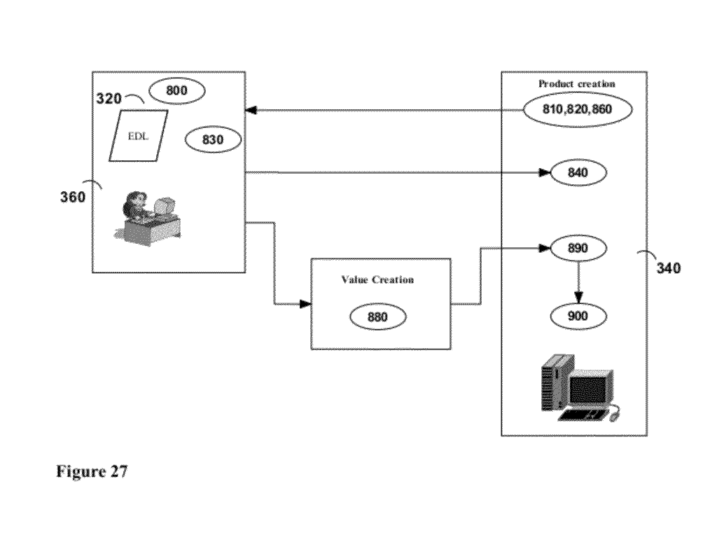

According to an embodiment of the present invention, a consumer can be permitted to modify the EDL. An illustration of this process is provided in FIGS. 25, 26 and 27. The process of negotiating the right to modify an EDL is represented graphically in FIG. 25. A process diagram detailing the steps involved in the process represented in FIG. 25 is provided in FIG. 26. A graphic representation of the process outlined in FIGS. 25 and 26 is provided in FIG. 27, which also details at which step in the process value is created.

With reference to FIGS. 25, 26, and 27 at step 800, the service provider makes the EDL 320 easily accessible, for example, in a database that is available over the Internet. The EDL 320 contains information that references content (not shown). In step 810, the consumer, who is interested in the new final product that the EDL generates, or who wishes to modify the EDL, locates the EDL and, in step 820, sends a request to the service provider 360. In step 830, the service provider 360 provides the consumer 340 with the terms and conditions to be agreed to before the right to modify the EDL can be granted. The terms and conditions can include such information as payment terms, rights of use and rights of distribution. In step 850, the consumer 340 reviews the terms and conditions and either chooses to accept them or not to accept them. If the consumer 340 chooses not to accept the terms and conditions, the consumer 340 will not receive the EDL 320. At step 860, the consumer 340 accepts the terms and conditions and transmits the acceptance to the service provider 360. In step 870, the service provider receives the confirmation of acceptance which could include payment for the right or license to access and edit the EDL; and/or, acceptance of an agreement concerning the use of the EDL. In step 880, the consumer obtains access to the EDL from the service provider 360. With reference to FIG. 27, it is at step 880 that value is created. This could be done for example, by downloading the EDL over the Internet, or the service provider can provide the tools and access needed so that the consumer can modify the EDL.

In step 900, the consumer proceeds to create a new EDL based on the original EDL, subject to the agreed upon parameters imposed by the editor. The modification can occur within a customized environment provided by the editor or any application that is compatible with the EDL. The consumer can then process the modified EDL accordingly and create a new product if desired. According to an embodiment, the consumer can now distribute the EDL that they have modified to other consumers and start the cycle again.

Class 3—Price Tracking

According to one embodiment of the present invention, content providers can calculate the value of the EDL based on the quantity and quality of elements that are used within an EDL. In one embodiment of the present invention, different elements of content can have individually assigned royalty payment rates.

According to one embodiment of the present invention, the content referenced in the EDL is not purchased from the content provider as a one-time sale. Instead, the use of the content is tracked automatically and is billed on a regular or ongoing basis. In this embodiment, the use of individual content elements is tracked and the sale of the complete content source is not required. This example is analogous to the current payment system for radio and television broadcasts where payment is determined over time as a factor of frequency of use rather than as a one-time transfer of ownership of the content.

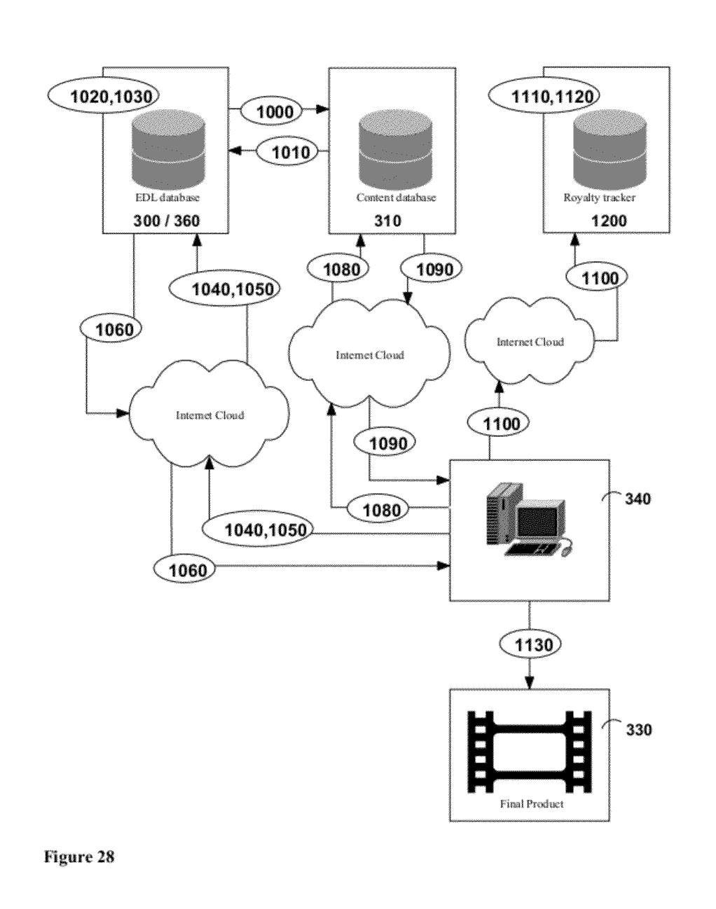

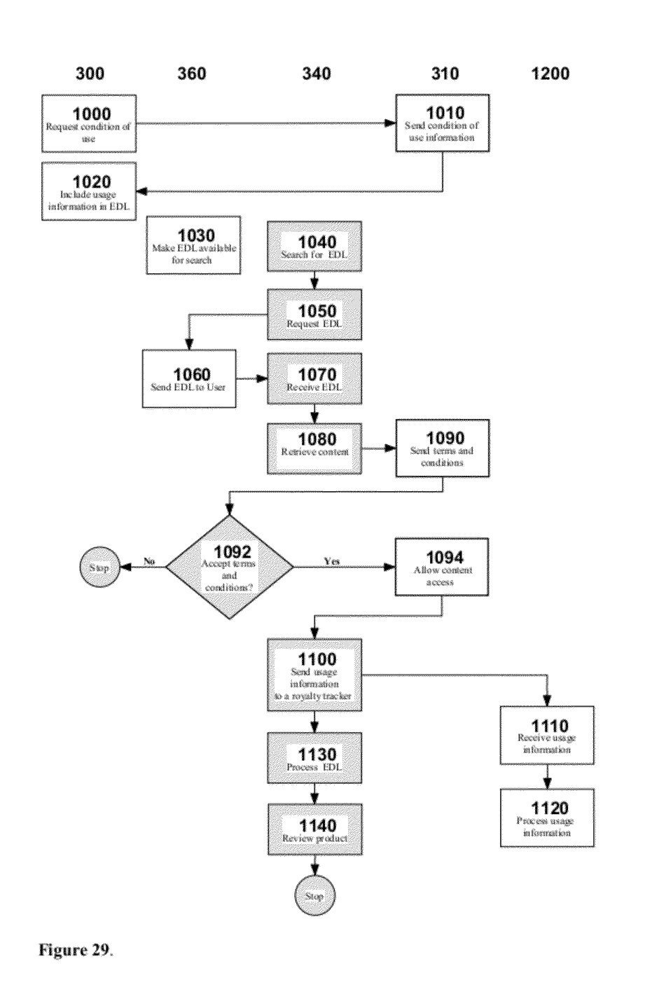

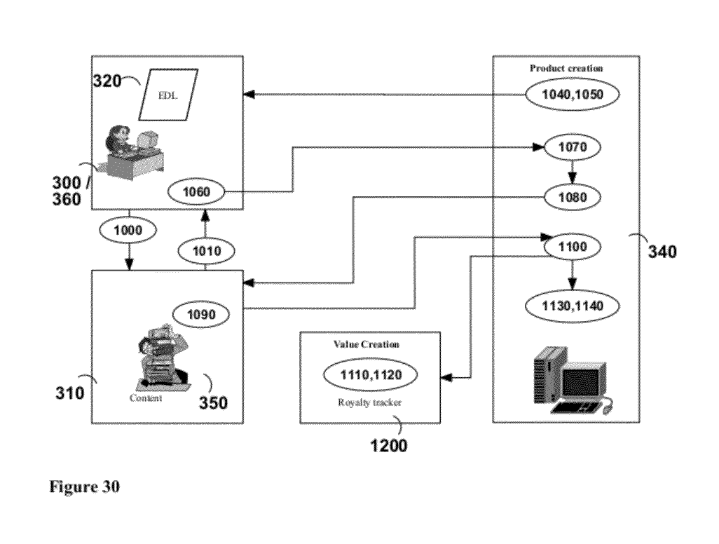

An illustration of this concept is provided in FIGS. 28, 29 and 30. FIG. 28 is a graphic representation of the process of tracking content use using a royalty tracker. FIG. 29 is a process diagram of the process illustrated in FIG. 28. FIG. 30 provides a graphic representation of the process outlined in FIGS. 28 and 29 and illustrates at what stage in this process value is created.

With reference to FIGS. 28, 29, and 30, the process begins at step 1000 when the editor 300 obtains content conditions of use terms from the content provider 310. Examples of condition of use terms could include, for example, frequency of use and cost per use. In step 1010, the content provider 310 receives the request and, sends condition of use information to the editor 300. As part of this request, the editor 300 and the content provider 310 can also establish an agreement on the tracking and processing of content use. In step 1020, the editor 300 includes the condition of use information in the EDL. Also, included in the EDL will be information on obtaining the various content materials and their individual elements. In step 1030, the service provider 360 makes the description of the EDL available for search and purchase. For example, the service provider 360 can store a description of the EDL in a database and make the database searchable over the Internet. In step 1040, a consumer 340 searches for the EDL. For example, the consumer can access a website that has a searchable list of EDLs and their descriptions. In step 1050, the consumer 340 requests the EDL. For example, if the EDL is available on a website, the consumer 340 can send a request for the EDL by clicking on a hyperlink on the website. In step 1060, the service provider 360 receives a request for a particular EDL, approves the request and sends that EDL to the consumer 340. In step 1070, the consumer 340 receives the EDL and starts processing the instructions contained in the EDL. In order to process the EDL, the consumer must first obtain the content from the content provider 310 or their service provider. In step 1080, the EDL triggers a prompt that requires the consumer 340 to obtain the content in order for the EDL to be processed. The consumer 340 sends a request for the source material to the content provider 310. For example, the request can be in the form of a web request or an email. At step 1090, after receiving the request, the content provider 310 sends the consumer 340 an agreement containing terms and conditions for accessing the content. Examples of terms that could be contained within such an agreement include: cost for each use of a content element, the billing period, payment means, rights of the content provider and consumer with respect to the use of the content and the final product, etc. At step 1092, the consumer 340 then transmits proof of their acceptance of the terms of the agreement to the content provider 310. If the consumer 340 does not accept the agreement, then the source content will not be available. At step 1094, the content provider 310 provides access to the content. For example, the content provider 310 can make the content file available as a download or can send the requested content file as an e-mail attachment. According to another embodiment, the terms and conditions are sent to the consumer along with the content. The consumer 340 then continues with the EDL instructions after receiving the content from the content provider 310. As part of the EDL instructions, the consumer's computing device (not shown) automatically tracks usage information by means of a royalty tracker 1200. The royalty tracker 1200 is a software application that receives, interprets and processes usage information according to the rules and agreements established by the content provider at the time of the initial transfer of the content. In step 1100, information on use of content is then transmitted to the royalty tracker 1200 using the internet or a wireless or wired connection. This royalty tracker 1200 can be a service provided by a service provider 360 or content provider 310 or a third party. Information that may be tracked includes the number of times a content element was used. In step 1110, the usage information is received and, in step 1120, is processed. With regard to FIG. 30, it is steps 1110 and 1120 in which value is created. This processing can be, for example, for the purpose of generating an invoice for the use of the content. In step 1130, the consumer 340, meanwhile, uses the EDL to generate the final product and, in step 1140, reviews it.

Class 4—Advertising

Targeted final products enabled by customized or interactive EDLs allow for targeted advertising as well. According to one embodiment, the content provider provides access to advertising content which is integrated into an EDL. Advertising content can take various forms, for example commercials, previews of other final products or segments of content including product placement. For example, a content provider could provide access to video content in the form of one scene of a movie in which the main character uses a particular product. An editor could reference the particular scene in an EDL wherein the final product would be targeted towards a particular audience who might desire that product. In this embodiment, a content provider and an editor could negotiate to have advertising content included in a final product through insertion in an EDL. In another embodiment, EDLs referencing advertisement content could be priced differently than EDLs that do not reference advertising content. Within the context of the present invention, advertisements are merely another type of content that can be incorporated into a final product as the editor chooses.

According to an embodiment of the present invention, customized or interactive EDLs can be used to create different versions of a final product with or without advertising. The advertising can also be monitored and altered to meet specific marketing goals on the part of the advertiser/content provider, the editor, or the service provider. For example, rules such as duration of advertisement cycle, and targeting based on demographics or geography can be included within the advertising function. According to one embodiment of the invention, the editor is awarded value for each unique version of the final content. By using the EDL to insert advertising content, the advertiser can target audiences more accurately. According to one embodiment, the advertising content is provided through the internet at the time the final product is compiled and EDLs refer to advertising content by its location on a server or in a database. Advertisers can then easily change which advertising content is being referenced by an EDL. For example, EDLs could be created to select any advertising content contained in a particular folder on a server. By changing the contents of the folder, an advertiser can continuously update their advertisements without the need to alter the EDL.

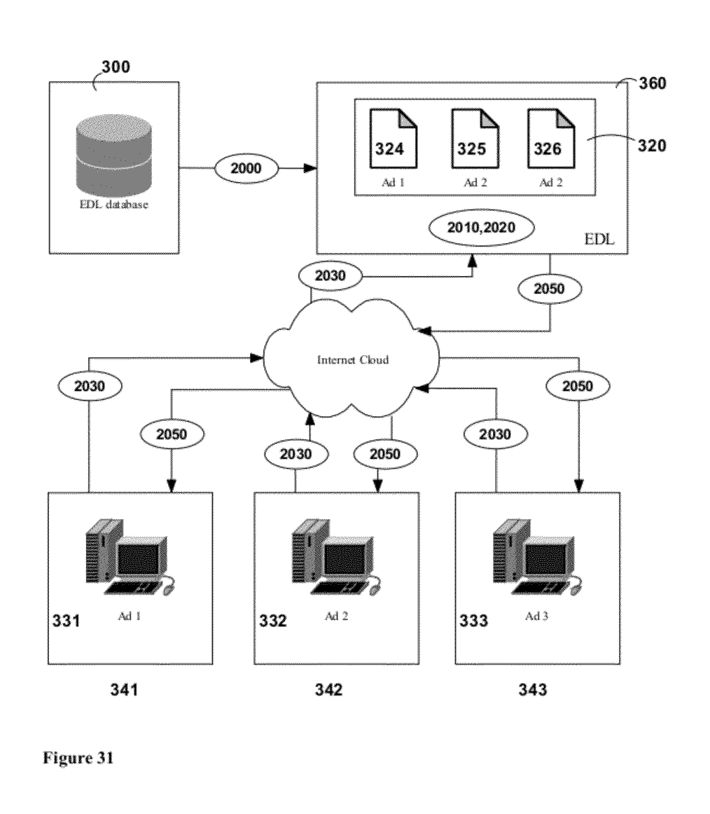

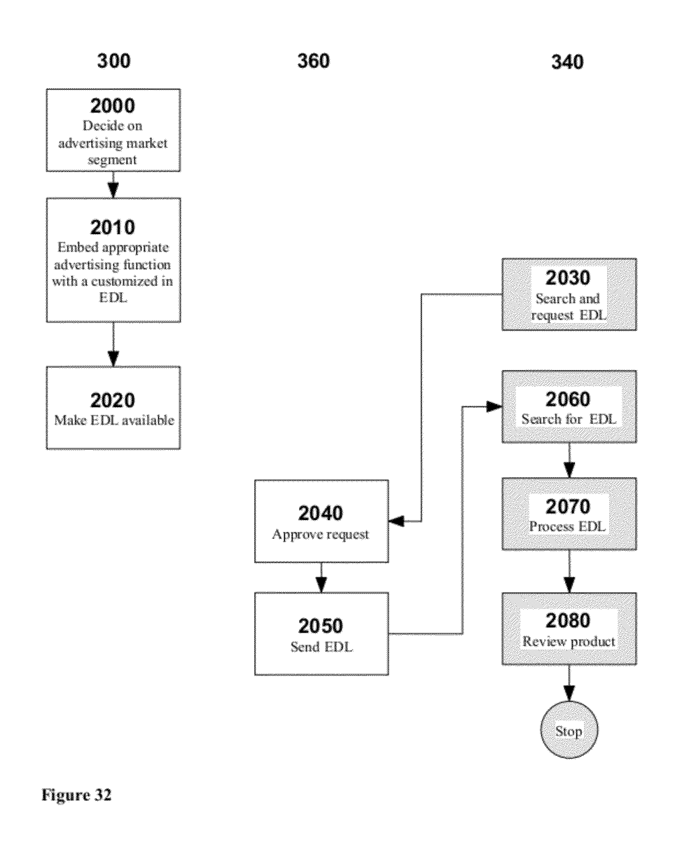

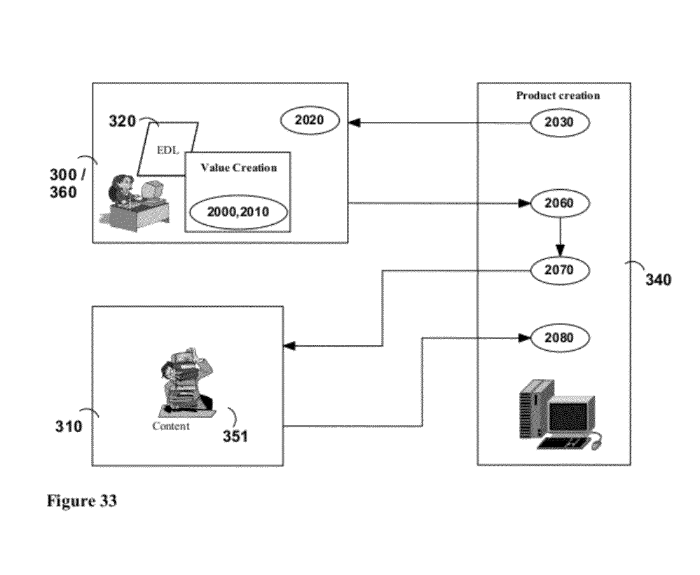

An illustration of this concept is provided with reference to FIGS. 31, 32 and 33. FIG. 31 provides a graphic representation of the process. FIG. 32 is the corresponding flowchart for the processes described in FIG. 31. FIG. 33 is a graphic representation of another embodiment of the invention in which the consumer obtains advertising content from the content provider. FIG. 33 also illustrates where value is created in the process.

With reference to FIGS. 31, 32 and 33, in step 2000, the editor 300 decides on the advertising market segment or segments that the EDL should target. The editor 310 then chooses the most appropriate advertising strategy for each market segment. According to one embodiment, this decision is made in conjunction with an advertiser/content provider or marketer. Each advertising strategy is encoded into an advertising function. Once the advertising strategy has been finalized, the editor 300 creates an appropriate advertising function for each segment of the targeted market. The advertising function is a set of instructions that controls the behavior of the advertising within the final product generated by the EDL. Examples of advertising functions include the type of advertising, the frequency of display and the placement of the advertising. Examples of advertising functions tailored for different geographical locations, languages, and marketing approaches could resemble the following:

a. Ad1: Worldwide, English, Do not like advertising but susceptible to product placement;

b. Ad2: Resides in North America; English; Accepts advertising;

c. Ad3: Resides in Europe; French; Accepts advertising;

Once the advertising functions have been created, the editor 310 creates EDL modification rules to satisfy the requirements of each advertising function. Such EDL modification rules could resemble the following:

a. Ad1 324: 1) No Ads; 2) Replace Object A that is in all content elements with Product A;

b. Ad2 325: 1) Includes Ads every 21 minutes; 2) Include only North American company advertising;

c. Ad3 326: 1) Include Ads every 26 minutes; 2) Include only French company advertising.

In step 2010, these rules, 324, 325 and 326 are incorporated into a single EDL 320. In step 2020, a service provider 360 makes the EDL 320 available to consumers. In step 2030, consumers 341, 342 and 343 belonging to particular advertising market segments locate the EDL 320. For example, the EDL 320 is discovered through a search over the internet by consumer 343 who speaks French. The consumers 341, 342 and 343 request the EDL 320 and, in steps 2040 and 2050, the service provider 360 approves the request and provides access to the EDL 320 to the consumers 341, 342 and 343. In step 2060, the consumers 341, 342 and 343 receive the EDL 320.

In step 2070, the consumers 341, 342 and 343 execute the instructions on the EDL 320. Step 2070 also involves the consumers 341, 342 and 343 providing input that determines which of the EDL modification rules 324, 325 or 326 are followed. The process steps for receiving and processing consumer input are discussed in detail in reference to FIGS. 19, 20 and 21.

In step 2080, individualized final products 331, 332 and 333 are created that contain appropriate advertising content for the individual consumer 341, 342 or 343.

According to another embodiment, the consumer obtains advertising content from a content provider as directed by an EDL. With regard to FIG. 33, the consumer 340 obtains an EDL 320 from an editor 300 or service provider 360. When the EDL 320 is processed, the consumer is directed by the EDL to obtain advertising content 351 from the content provider 310. FIG. 33 also illustrates that it is steps 2000 and 2010 in which value is created.

According to another embodiment, the process of providing EDLs that reference advertising content in a targeted fashion is accomplished using multiple customized EDLs as opposed to an interactive EDL as discussed above.

A worker skilled in the art will appreciate that the foregoing embodiments of the invention are exemplary and can be varied in many ways. Such present or future variations are not to be regarded as a departure from the spirit and scope of the invention, and all such modifications as would be obvious to one skilled in the art are intended to be included within the scope of the following claims.

### EXAMPLES

The following examples illustrate commercial applications of EDL technology. The combination of extracting the value of the EDL and the commercialization of this value will create business processes not currently found in the marketplace. The premise of each example is an internet-based transaction; however, the same process can be easily modified and adapted to other types of network configurations. Examples of other types of network configurations include a cellular network or a wireless local area network. The examples can also be mixed and combined to form new and more complex applications and processes.

The invention will now be described with reference to specific examples. It will be understood that the following examples are intended to describe embodiments of the invention and are not intended to limit the invention in any way.

### EXAMPLE 1

### Example 1

As discussed in greater detail above, the present invention allows for the creation of an efficient system for generating and distributing content to consumers.

1A—Distributing Films

In this example, an editor has a relationship with a content provider wherein the editor is allowed to access content owned by the content provider for the purpose of creating EDLs. The editor creates an EDL referencing content owned by the content provider that creates a final product, in this example a film. The editor and the content provider enter into a relationship with a service provider, who agrees to administer the granting of access to the EDL and the content to consumers. A consumer learns about the film and buys a copy of the EDL from the service provider. The transaction could also include a unique password that will enable the consumer to access content owned by the content provider and referenced in the EDL. The service provider divides the money received from the consumer between the service provider, the editor, and the content provider according to the terms of their relationship. The consumer processes the EDL which directs the consumer to contact the content provider to obtain the content. The consumer goes to the content provider's website and inputs the password provided by the service provider. The consumer is then granted access to download or stream the content provided by the content provider so as to assemble the final product.

1B—Tracking Use

An example of a use of the present invention could be to track the use of final products by using EDLs to provide a unique copy of final content to each consumer. Content providers may wish to enforce license agreements with consumers that allow them to use final products only for their own personal use. One way to accomplish this would be to provide an EDL to a service provider that associates identifying information for a consumer with a unique element of the final product produced by that EDL. For example, a consumer agrees to certain terms and conditions in order to access an EDL. One of the terms and conditions is that the consumer will not distribute copies of the final product to other consumers. The consumer accesses and processes the EDL, which creates a final product containing a unique watermark. At the same time, the EDL instructs the consumer's computing device to transmit a message to the service provider containing identifying information about the consumer, such as for example the computing device's IP address, along with information regarding the unique watermark. If the final product is subsequently distributed, the service provider can analyse the final product and cross reference the watermark with the identity of the consumer who has not complied with the terms and conditions.

### Example 2

As discussed in greater detail above, according to different embodiments of the invention, entities within the system, namely, the editor, service provider, content provider, and consumer can take on more than one role. In the following examples, an editor creates an EDL based on content that a targeted consumer will already possess. This simplifies the operation of the invention as the content provider and the consumer are the same entity.

2A—Fan Films

In this example, an editor creates an EDL that references content owned by a targeted consumer, such as DVDs of a particular movie or television series. Popular television shows that have run for multiple seasons and popular movie franchises create large pools of content that will likely already be in the possession of fans of that particular show or franchise. By sampling content from these DVDs, an editor can potentially create new final products that take place in the same universe as the original television show or movie. In this example, the consumers who would be most interested in the new final product created by the EDL would also be the most likely to be owners of the content. The editor or a third party content provider may also reference externally created audio or visual content, such as additional scenes or dialogue, where desired. Such additional content would need to be obtained by the consumer; however, it will likely form a minimal part of the final product. This example could also include updating old television shows or movies to update special effects, colours, or audio tracks.

2B—Fan Films 2

In this example, a group of fans organize and create a short film referencing characters and locales from an existing television show and record dialogue and music for their film. The group makes their content freely available to other fans. An editor, who may or may not be connected to the original group of fans, creates an EDL that combines the video, multimedia and audio content to generate a final product (i.e. the short film). The EDL can be sold to other fans who wish to see the final product.

2C—Film Competition

In this example, a production company makes video, audio, and multimedia content available to the public and holds a contest with a prize for the best final product incorporating that content. Editors can access the content and submit their EDL to the production company. The EDLs can then be made available to the public to access and review the final product. People can then vote on their favourite final product. Alternatively, the competition could be judged by a jury of experts. The prize could be professional distribution of the winning final product.

2B—Music Sampling

The process of re-mixing popular music to create new versions of a song is well known in the art. In the genre of hip hop music, for example, artists often create songs that are collages of audio content elements from other songs, such as drum beats, along with content created by the artist. In this example, using the present invention, this re-mixing could take place on a consumer's own computing device using EDLs and a consumer's own music collection. The consumer would gain access to the EDL which would either search the consumer's computing device for digital audio content, or prompt the consumer to supply audio content, for example in the form of audio CDs. The final product could be comprised solely of content owned by the consumer or could additionally comprise audio content supplied by a third party.

1. A system for providing a consumer access to a final product comprising one or more content elements, the system comprising:
an edit decision list corresponding to the final product, said edit decision list comprising statements and instructions for generating the final product from said one or more content elements;
a selection means for allowing the consumer to select the edit decision list from a first source location;
a computing device accessible to the consumer and having access to said one or more content elements from one or more second source locations distinct from said first source location; and
a communication medium for providing said computing device access to said edit decision list;
wherein said computing device is configured to access said edit decision list and implement said statements and instructions thereof to generate the final product for consumption by the consumer.

2. The system of claim 1, wherein said one or more content elements comprise any combination of the following video, audio, text, images and multimedia content.

3. The system of claim 1, wherein the generation of said final product from said one or more content elements comprises one or more of manipulating, arranging, modifying, condensing, separating, or altering said one or more content elements.

4. The system of claim 1, wherein access to said first source location and said second source location is provided via a service provider.

5. The system of claim 2, wherein said service provider centrally provides said consumer access to a plurality of second source locations for accessing distinct content element sources.

6. The system of claim 1, wherein said second source location comprises a consumer's personal collection of content elements.

7. The system of claim 4, wherein said consumer is granted the right to modify the instructions contained within the edit decision list from said service provider.

8. The system of claim 1, wherein said one or more content elements comprise advertising content.

9. A method of providing a consumer access to a final product comprising one or more content elements:
having the consumer select an edit decision list referencing said one or more content elements from a first source location;
providing the consumer access to said selected edit decision list;
providing the consumer access to the one or more content elements referenced by said selected edit decision list from one or more second source locations distinct from said first source location;
having the consumer generate the final product from said one or more content elements.

10. The method of claim 9, wherein said one or more content elements comprise any combination of the following video, audio, text, images and multimedia content.

11. The method of claim 9, wherein the generation of said final product from said one or more content elements comprises one or more of manipulating, arranging, modifying, condensing, separating, or altering said one or more content elements.

12. The method of claim 9, wherein access to said first source location and said second source location is provided via a service provider.

13. The method of claim 12, wherein said service provider centrally provides said consumer access to a plurality of second source locations for accessing distinct content element sources.

14. The method of claim 9, wherein said second source location comprises a consumer's personal collection of content elements.

15. The method of claim 12, wherein said consumer is granted the right to modify the instructions contained within the edit decision list from said service provider.

16. The method of claim 9, wherein the said one or more content elements comprise advertising content.

17. A system for tracking the use of a final product by a consumer, the final product comprising one or more content elements to be assembled the system comprising:
an edit decision list corresponding to the final product, said edit decision list comprising statements and instructions for generating the final product from one or more content elements and comprising instructions for inserting a unique identifier into said final product at the time of assembly;
a selection means for allowing said consumer to select the edit decision list from a first source location;
a computing device accessible to said consumer and having access to said one or more content elements from one or second source location distinct from said first source location; and
a communication medium for providing said computing device access to said edit decision list;
wherein said computing device is configured to access said edit decision list and implement said statements and instructions thereof to generate said unique final product for consumption by the consumer
and wherein said unique identifier can be used to associate said final product with either or both of said first or said second source location.

18. The system of claim 17, wherein said one or more content elements comprise any combination of the following video, audio, text, images and multimedia content.

19. The system of claim 17, wherein the generation of said final product from said one or more content elements comprises one or more of manipulating, arranging, modifying, condensing, separating, or altering said one or more content elements.

20. The system of claim 17, wherein access to said first source location and said second source location is provided via a service provider.

21. The system of claim 20, wherein said service provider centrally provides said consumer access to a plurality of second source locations for accessing distinct content element sources.

22. The system of claim 17, wherein said second source location comprises a consumer's personal collection of content elements.

23. The system of claim 17, wherein the said one or more content elements comprise advertising content.

24. A system for providing a consumer access to two or more final products comprising one or more content elements wherein each of said two or more final products are specifically tailored to appeal to a consumer based on one or more criteria, the system comprising:
an edit decision list corresponding to said two or more final products, said edit decision list comprising statements and instructions for generating said two or more final products from one or more content elements;
a selection means for allowing the consumer to select the edit decision list from a first source location;
a computing device accessible to the consumer and having access to said one or more content elements from one or more second source locations distinct from said first source location;
a communication medium for providing said computing device access to said edit decision list; and
an input means for allowing the consumer to provide input, wherein said input corresponds to one or more criteria relating to said consumer;
and wherein said computing device is configured to access said edit decision list and implement said statements and instructions thereof and said input to generate a particular final product for consumption by the consumer.

25. The system of claim 24, wherein said one or more criteria comprises any combination of the following: unique identifier, age, gender, profession, interest, genre, and language.

26. The system of claim 24, wherein the generation of said final product from said one or more content elements comprises one or more of manipulating, arranging, modifying, condensing, separating, or altering said one or more content elements.

27. The system of claim 24, wherein said one or more content elements comprise any combination of the following video, audio, text, images and multimedia content.

28. The system of claim 24, wherein access to said first source location and said second source location is provided via a service provider.

29. The system of claim 28, wherein said service provider centrally provides said consumer access to a plurality of second source locations for accessing distinct content element sources.

30. The system of claim 24, wherein said second source location comprises a consumer's personal collection of content elements.

31. The system of claim 24, wherein the said one or more content elements comprise advertising content.

32. A system for providing a consumer access to two or more final products comprising one or more content elements wherein each of said two or more final products are specifically tailored to appeal to a consumer based on one or more criteria, the system comprising:
an edit decision list corresponding to said two or more final products, said edit decision list comprising two or more sublists, wherein each sublist comprises statements and instructions for generating one of said two or more final products from one or more content elements;
a selection means for allowing the consumer to select the edit decision list from a first source location;
a computing device accessible to the consumer and having access to said one or more content elements from one or more second source locations distinct from said first source location;
a communication medium for providing said computing device access to said edit decision list; and
an input means for allowing the consumer to provide input, wherein said input corresponds to one or more criteria relating to said consumer;
and wherein said computing device is configured to access said edit decision list, select one of said two or more sublists based on said input, and implement said statements and instructions within said sublist to generate a particular final product for consumption by the consumer.

33. The system of claim 32, wherein said one or more criteria comprises any combination of the following: unique identifier, age, gender, profession, interest, genre, and language.

34. The system of claim 32, wherein the generation of said final product from said one or more content elements comprises one or more of manipulating, arranging, modifying, condensing, separating, or altering said one or more content elements.

35. The system of claim 32, wherein said one or more content elements comprise any combination of the following video, audio, text, images and multimedia content.

36. The system of claim 32, wherein access to said first source location and said second source location is provided via a service provider.

37. The system of claim 36, wherein said service provider centrally provides said consumer access to a plurality of second source locations for accessing distinct content element sources.

38. The system of claim 32, wherein said second source location comprises a consumer's personal collection of content elements.

39. The system of claim 32, wherein the said one or more content elements comprise advertising content.
